(19) United States
(12) Patent Application Publication
(10) Pub. No.: US 2023/0120916 A1
(43) Pub. Date: Apr. 20, 2023

(54) MODULAR ACCESSORIES AND STORAGE SYSTEMS

(71) Applicant: TECHTRONIC CORDLESS GP, Anderson, SC (US)

(72) Inventors: Jeffrey Groves, Greenville, SC (US); Tyler H. Knight, Mauldin, SC (US); Connor S. Irwin, Greenville, SC (US); J. Luke Jenkins, Williamston, SC (US); Benjamin P. Politte, Greenville, SC (US); Keith Lombardi, Easley, SC (US); Thomas Evatt, Six Mile, SC (US); Kyle B. Yeomans, Easley, SC (US); Jeremy Fedrigon, Greenville, SC (US); Sage D. Van Wyk, Greenville, SC (US); Trevor C. Fauss, Greenville, SC (US); Mehul Patel, Greenville, SC (US); John D. Parsons, Greenville, SC (US); Lik Hui, Hong Kong (CN); King Pun Hui, Hong Kong (CN)

(21) Appl. No.: 18/047,498

(22) Filed: Oct. 18, 2022

Related U.S. Application Data
(60) Provisional application No. 63/256,859, filed on Oct. 18, 2021.

(51) Int. Cl. B25H 3/04; B25H 3/02

(52) U.S. Cl. CPC B25H 3/04; B25H 3/022

(57) ABSTRACT

The present disclosure is a modular accessory that is compatible with a first storage component that has first mount interfaces, and a second storage component that is different from the first storage component that has second mount interfaces. The modular accessory includes a structure and an accessory mount. The structure is configured to hold or support one or more objects. The accessory mount is coupled to the structure and defines an accessory mount interface. The accessory mount interface is configured to engage one or more first mount interfaces and one or more of the second mount interfaces.

### CROSS-REFERENCE TO RELATED APPLICATIONS

This application claims priority to co-pending U.S. Provisional Patent Application No. 63/256,859 filed on Oct. 18, 2021, the entire content of which is incorporated herein by reference.

### BACKGROUND

Modular accessories and storage systems allows users to create customized solutions for organizing their homes, garages, and other spaces. For example, users can install modular storage systems including customized arrangements of bins, shelves, hooks and/or the like to create an organized space that fits the user's specific needs.

### SUMMARY

In one embodiment, the present subject matter provides, in one aspect, a modular accessory compatible with a first storage component that has mount interfaces and a second storage component that is different from the first storage system that has second mount interfaces. The modular accessory includes a structure and an accessory mount. The structure is configured to hold or support one or more tools. The accessory mount is coupled to the structure and defines an accessory mount interface. The accessory mount interface is configured to engage one or more of the first mount interfaces and one or more of the second mount interfaces.

In one embodiment, the present subject matter provides, in one aspect, integral formation of the accessory mount with the structure.

In one embodiment, the present subject matter provides, in one aspect, a system that includes a first storage component, a second storage component, a modular accessory, and an accessory mount. The first storage component has one or more first mount interfaces. The second storage component is different from the first storage component and includes one or more second mount interfaces. The modular accessory includes a structure that is configured to hold or support one or more objects. The accessory mount is coupled to the modular accessory and defines an accessory mount interface. The accessory mount interface is configured to engage one or more of the first mount interfaces, and one or more of the second mount interfaces.

In one embodiment, the present subject matter provides, in one aspect, a wall rail that is configured to attach to a wall and a second storage system including a toolbox.

In one embodiment, the present subject matter provides, in one aspect, an accessory mount that is configured to separately engage the first storage component and the second storage component without modification of the accessory mount.

Other aspects of the invention will become apparent by consideration of the detailed description and accompanying drawings.

### BRIEF DESCRIPTION OF THE DRAWINGS

FIG. 1 is a perspective view of a rail of a storage system.

FIG. 2 is a section view of the rail of FIG. 1.

FIG. 3 is a perspective view of a storage bin including an integral cart of a storage system.

FIG. 4 is a perspective view of another exemplary storage bin of a storage system.

FIG. 5 is a perspective view of the interior of the storage bin of FIG. 3.

FIG. 6 is a perspective view of a mount interface of the storage bin of FIG. 3.

FIG. 6A is a perspective view of a mount interface of the storage bin of FIG. 3.

FIG. 6B is a perspective view of a mount interface of the storage bin of FIG. 3.

FIG. 6C is a perspective view of a mount interface of the storage bin of FIG. 3.

FIG. 6D is a perspective view of a mount interface of the storage bin of FIG. 3.

FIG. 6E is a perspective view of a mount interface of the storage bin of FIG. 3.

FIG. 7 is a perspective view of another embodiment of a mount interface of the storage bin of FIG. 3.

FIG. 8 is a section view illustrating the mount interface of the storage bin of FIG. FIG. 7 and an accessory interface of an accessory.

FIG. 9 is a perspective view of an accessory including an accessory interface.

FIG. 10 is a perspective view of the accessory of FIG. 9 coupled to a wall rail.

FIG. 11 is a section view of the accessory and wall rail of FIG. 10.

FIG. 12 is a perspective view of an accessory including another embodiment of an accessory interface.

FIG. 13 is a perspective view of the accessory of FIG. 12 coupled to a wall rail.

FIG. 14 is a perspective view of an accessory including another embodiment of an accessory interface.

FIG. 15 is a perspective view of the accessory of FIG. 14 coupled to a wall rail.

FIG. 16 is a section view of the accessory and wall rail of FIG. 15.

FIG. 17 is a perspective view of an accessory including another embodiment of an accessory interface.

FIG. 18 is a section view of the accessory of FIG. 17 coupled to a wall rail.

FIG. 19 is a section view of the accessory and wall rail of FIG. 18.

FIG. 20 is a perspective view of an accessory including another embodiment of an accessory interface.

FIG. 21 is a perspective view of the accessory of FIG. 20 coupled to a wall rail.

FIG. 22 is a section view of the accessory and wall rail of FIG. 21.

FIG. 23 is a perspective view of an accessory including another embodiment of an accessory interface.

FIG. 24 is a perspective view of the accessory of FIG. 23 coupled to a wall rail.

FIG. 25 is a section view of the accessory and wall rail of FIG. 24.

FIG. 26 is a perspective view of an accessory including another embodiment of an accessory interface.

FIG. 27 is a perspective view of the accessory of FIG. 26 coupled to a wall rail.

FIG. 28 is a section view of the accessory and wall rail of FIG. 27.

FIG. 29 is a perspective view of an accessory including another embodiment of an accessory interface.

FIG. 30 is a perspective view of the accessory of FIG. 29 coupled to a wall rail.

FIG. 31 is a section view of the accessory and wall rail of FIG. 30.

FIG. 32 is a perspective view of an accessory including another embodiment of an accessory interface.

FIG. 33 is a perspective view of the accessory of FIG. 32 coupled to a wall rail.

FIG. 34 is a section view of the accessory and wall rail of FIG. 33.

FIG. 35 is perspective view of another embodiment of an accessory interface.

FIG. 36 is a perspective view of the accessory interface of FIG. 35.

FIG. 37 is a perspective view of another embodiment of an accessory illustrated as an accessory case, including the accessory interface of FIG. 36.

FIG. 38 is a perspective view of the accessory case of FIG. 37 mounted on a wall rail.

FIG. 39 is a perspective view of the accessory case of FIG. 37.

FIG. 40 is a perspective view of the accessory case of FIG. 37.

FIG. 41 is a perspective view another accessory embodied as a tool holster.

FIG. 42 is a perspective view of the tool holster of FIG. 41 mounted in a storage bin.

FIG. 43 is a perspective view of another accessory embodied as a battery holster.

FIG. 44 is a perspective view of the battery holster of FIG. 43 mounted in a storage case.

FIG. 45 is a perspective view of another accessory embodied as a top tray.

FIG. 46 is a perspective view of another accessory embodied as an extrusion mount for attaching another accessory to a storage bin.

FIG. 47 is a perspective view of the extrusion mount of FIG. 46 attached to an exemplary storage case and supporting another accessory.

FIG. 48 is a perspective view of the extrusion mount of FIG. 46 attached to the storage bin and supporting another accessory.

FIG. 49 is a perspective view of another embodiment of an accessory.

FIG. 50 is a perspective view of the accessory of FIG. 49 including a lid.

FIG. 51 is a perspective view of another accessory embodied as a top tray of a stacking tray system.

FIG. 52 is a perspective view of the stacking tray system of FIG. 51 including a lid.

FIG. 53 is a perspective view of the stacking tray system of FIG. 51 including a lid and a lower tray.

FIG. 54 is a front view of another accessory embodied as a small parts organizer.

FIG. 55 is a rear view of the small parts organizer of FIG. 54.

FIG. 56 is a perspective view of a drawer of the small parts organizer of FIG. 54.

FIG. 57 is a perspective view of another accessory embodied as a tool organizer.

FIG. 58 is a perspective view of the tool organizer of FIG. 57.

FIG. 59 is a perspective view of another accessory embodied as a tube dispenser.

FIG. 60 is a perspective view of the tube dispenser of FIG. 59.

FIG. 61 is a perspective view of another accessory embodied as a sandpaper storage folder.

FIG. 62 is perspective view of the sandpaper storage folder of FIG. 61.

FIG. 63 is a perspective view of another accessory embodied as circular saw blade storage.

FIG. 64 is a perspective view of the circular saw blade storage of FIG. 63.

FIG. 65 is a perspective view of another embodiment of a circular saw blade storage.

FIG. 66A is a perspective view of the circular saw blade storage of FIG. 65.

FIG. 66B is a perspective view of the circular saw blade storage of FIG. 65.

FIG. 67 is a perspective view of embodiments of the circular saw blade storage, including a wall rail.

FIG. 68 is a perspective view of a storage mount coupled to a wall rail.

FIG. 69 is a perspective view of another embodiment of a circular saw blade storage.

FIG. 70 is a perspective view of another embodiment of a circular saw blade storage.

FIG. 71 is a perspective view of another accessory embodied as a belt clip.

FIG. 72 is a perspective view of the belt clip of FIG. 71.

FIG. 73 is a perspective view of another accessory embodied as a storage panel.

FIG. 74 is a rear view of the storage panel of FIG. 73.

### DETAILED DESCRIPTION

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways.

A. Wall Rail and Mount Interfaces

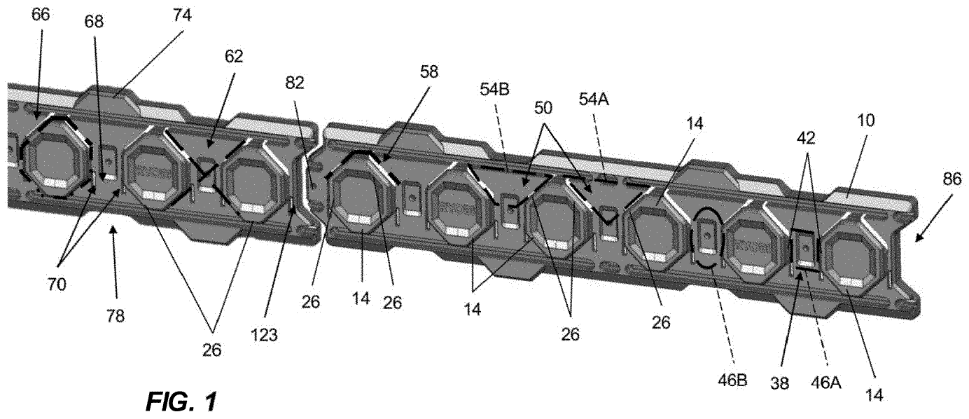

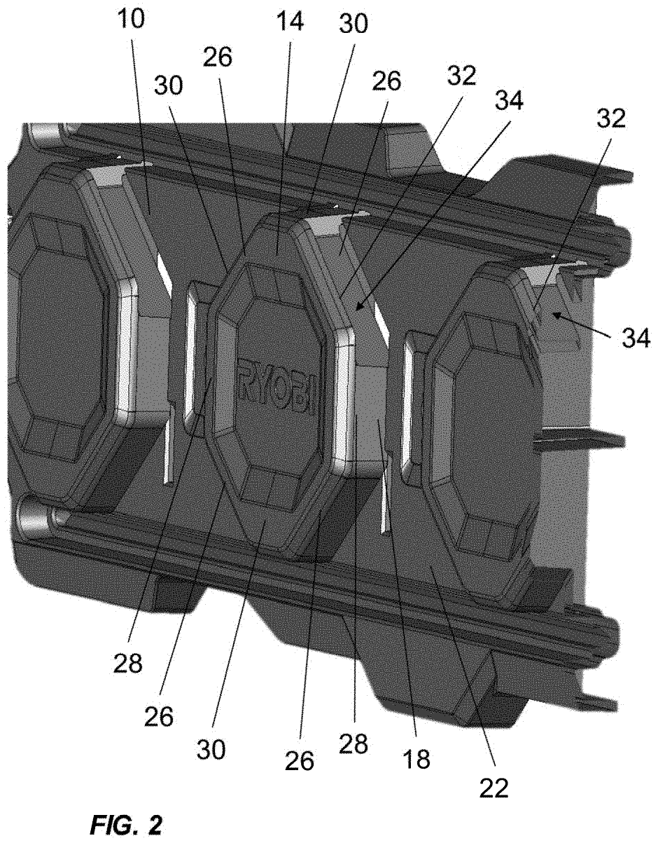

FIGS. 1 and 2 illustrate a wall rail 10 of a modular storage system. An exemplary storage system in which the wall rail 10 can be included is shown and described for instance, in U.S. patent application Ser. No. 17/153,251, filed Jan. 20, 2021, (published as US 2021/0221561), and U.S. patent application Ser. No. 17/396,282, filed Aug. 6, 2021, (published as US 2022/0040842), the entire content of each application incorporated herein by reference. The wall rail 10 may include a plurality of protrusions 14 (e.g., hanging structures, projections, cleats, and/or the like) repeated along a length of the wall rail 10, which may be engaged by a modular accessory to mount the modular accessory to the wall rail 10. As best shown in in FIG. 2, the protrusions 14 may include octagonally-shaped structures with each protrusion 14 including a base portion 18 that extends from a surface 22 of the wall rail 10, a plurality of angled portions 26 (e.g., two upper angled sides, two lower angled sides, and/or the like), two or more vertical sides 28 joining upper and lower angled portions 26, and two or more substantially horizontal sides 30. The upper angled sides may each define a lip, a ledge, or an overhang portion 32 that extends outward from the base portion 18 and defines an undercut 34 between the overhang portion 32 and the surface 22 of the wall rail 10. As persons having skill in the art will appreciate, protrusions 14 may include any other suitable geometric shape (i.e., a different shape than an octagon) without deviating from the instant disclosure.

One or more mount interfaces may be disposed proximate to and/or adjacent to a single protrusion 14 or such mount interfaces may be disposed proximate to and/or between two adjacent protrusions 14. For example, in some embodiments, a mount interface is a first mount interface 38 (FIG. 1) disposed between edges or sides of two adjacent protrusions 14. Note that wall rail 10 may include a variety of differently sized and/or shaped mount interfaces formed thereon, including but not limited to those shown in broken/phantom lines in FIG. 1. Such mount interfaces may be in the form of regions, areas (e.g., planar areas), or portions of the wall rail 10 that are configured to interface with a modular accessory as described herein. That is, one or more modular accessories may mount or attach to the wall rail 10 at one or more mount interfaces, and occupy at least a portion of the area defined by such mount interfaces. In some embodiments, the first mount interface 38 may be substantially rectangular in shape for receiving and/or interfacing with an accessory interface (described below) having a predetermined profile that is configured to mount to, attach to, and/or otherwise interface with the first mount interface 38. Other sizes and/or shapes of mounting interfaces are contemplated (e.g., square shapes, polygonal shapes, rhombus shapes, symmetric shapes, asymmetric shapes, regular shapes, irregular shapes, and/or the like, may be formed and employed as mount interfaces on the wall rail 10). As FIG. 1 further illustrates, the first mount interface 38 may occupy a space proximate and adjacent to a single protrusion 14 and/or a space proximate to and between adjacent protrusions 14. Such spaces and, thus, such mount interfaces may be formed as a rectangular region 46A, an oval region 46B, and/or the like.

In some embodiments, the mount interface is a second mount interface 50 positioned between two adjacent protrusions 14 (e.g., between upper, angled portions 26 of the two adjacent protrusions 14) and is at least partially defined by undercuts 34 formed in the overhang portions 32. The second mount interface 50 may have triangular or trapezoidal profiles 54A, 54B and/or shapes (e.g., planar shapes). In some embodiments, the mount interface is a third mount interface 58 as defined by the upper angled portions 26 of a single protrusion 14. As shown in FIG. 1, the third mount interface 58 may be in the form of an inverted U-shape, an inverted V-shape, and/or the like, and be configured to receive a suitably shaped modular accessory thereon, as shown and described herein.

In some embodiments, the mount interface is a fourth mount interface 62 defined by and between the upper and lower angled portions 26 of two adjacent protrusions 14 defining an X-shape. One or more modular accessories having a suitably shaped accessory interface (e.g., as described below, such accessory interface may optionally be spring-loaded to occupy the area defined by the X-shape 62) may be mounted or attached to the fourth mount interface 62. The fourth mount interface 62 may be formed as or in an X-shaped area or region defined between upper and lower angled portions of adjacent protrusions 14. The fourth mount interface 62 may additionally be formed in the space between two adjacent rails, so that the vacant spaces on the very ends of adjacent rails 10 may be collectively utilized for mounting modular accessories thereto. In this case, the modular accessory could occupy space on two adjacent wall rails 10 (e.g., a modular accessory could occupy ends spaces 123 of a first wall rail and a second wall rail). In this way, the wall rail 10 may accommodate a large number of modular accessories for providing users with any number of options for providing customized storage systems.

Still referring to FIG. 1, and in some embodiments, the mount interface is a fifth mount interface 66 defined by the upper and lower angled portions 26, substantially vertical sides 28 and horizontal sides 30 of one of the protrusions 14. In some embodiments, the mount interface is a sixth mount interface 68 as defined by one or more slots 70 spaced along the wall rail 10. As illustrated, the slots 70 may be spaced such that two slots are positioned between adjacent protrusions 14, with each slot 70 positioned adjacent each substantially vertical sides 28 of the protrusions 14. The slots 70 may be positioned in other locations on the wall rail 10 at regular or irregular increments along the wall rail 10. Hooks may be hangable from the slots 70 and modular accessories may be hangable therefrom. As persons of skill in the art will appreciate, other sizes and shapes of the mount interfaces described herein may be defined over any given region(s) of the wall rail 10 for mounting a modular accessory thereto. That is, a modular accessory may be movable between the wall rail 10 and/or other storage components (e.g., a toolbox, a crate, and/or the like) as described herein. In this way, a user may create a customized organizational scheme for modular accessories (e.g., batteries, tools, blades, etc.) at various points or locations (e.g., on a wall rail, in a toolbox) of a storage system.

The wall rail 10 may additionally includes alignment structures (e.g., horizontal alignment protrusions 74 alignable with horizontal alignment recesses 78, vertical alignment protrusions 82 alignable with vertical alignment recesses 86) to vertically and horizontal align a plurality of wall rail 10. The alignment structures (74 and 78) may form and/or define mount interfaces to which modular accessories may be mounted or attached.

B. Storage Components and Mount Interfaces

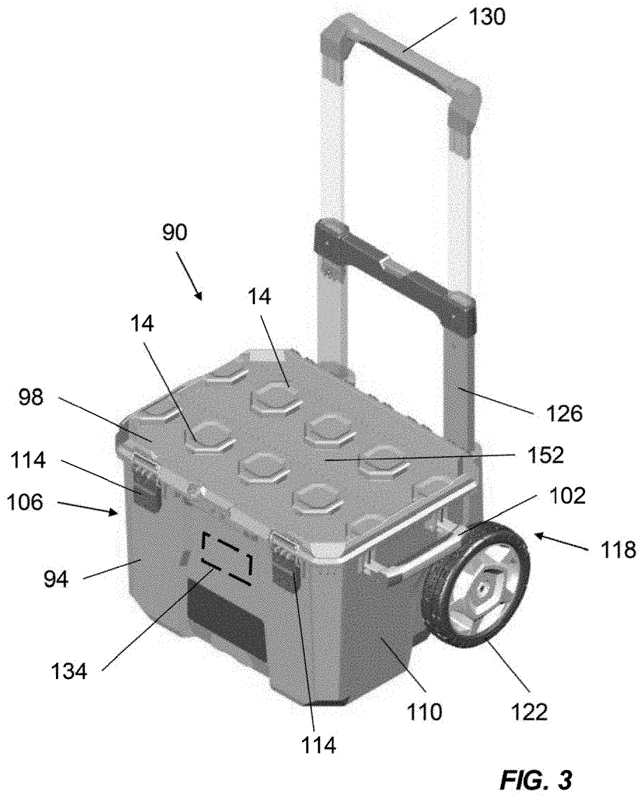

FIGS. 3-8 illustrate a storage component, such as a storage bin or toolbox 90 of a modular storage system. The toolbox 90 has a base 94 and a lid 98 pivotally coupled to the base 94. One or more handles 102 may extend from opposing 106, 110 of the base 94 or from any other side(s) of the toolbox 90. One or more latches 114 may be pivotally coupled to the base 94 and engage the lid 98 to secure the lid 98 to the base 94 when the lid 98 is in a closed position (FIG. 3). The toolbox 90 may optionally be integrally formed with a cart 118. In some embodiments, the cart 118 may include a pair of wheels 122 that are coupled to the sides 106, 110 of the base 94 and a handle 126 with a grip portion 130 may telescopically extend from the base 94. In some embodiments, the toolbox 90 may include a light source 134, such as a light emitting diode (LED) or LED panel.

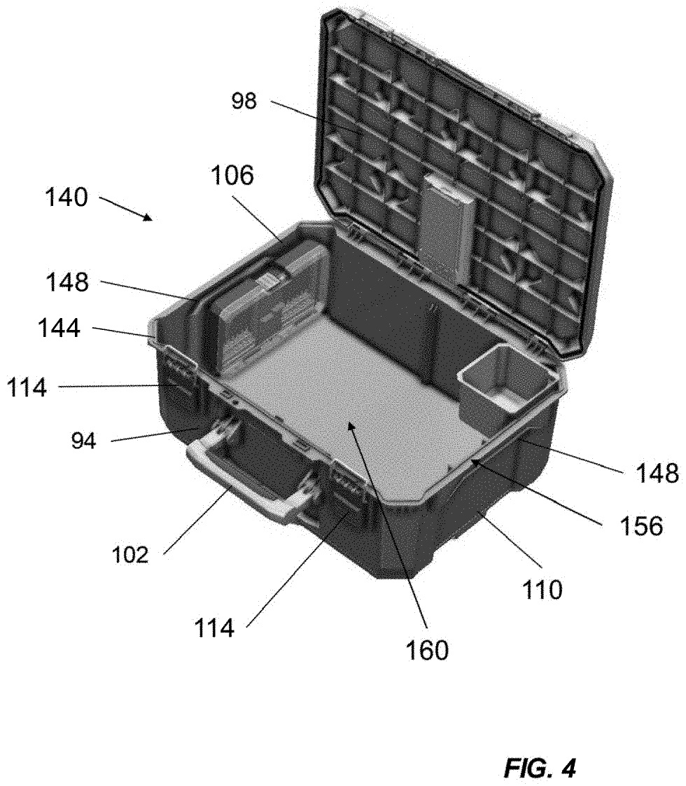

In some embodiments (FIG. 4), a toolbox 140 has a rigid or soft base 144 that does not include a pair of wheels or a telescopically extendible handle. The toolbox 140 may include gripping portions 148 positioned on opposing sides 106, 110 of toolbox 140. In other embodiments, the base 144 may be a cooler structure having insulated walls. In still other embodiments, the toolbox 140 may receive a cooler bag having an insulative structure that is insertable into the interior of the toolbox 90. In still other embodiments, the toolbox may receive a soft drop-in insert (e.g., an insert formed from cloth, canvas, polyester, clear plastic, etc.) or multiple inserts that can be coupled (e.g., via hook and loop fasteners) in different configurations. In still other embodiments, the lid 98 may be couplable to the base by 94 a zipper.

The toolboxes described herein (e.g., 90, 140, and/or the like) may include one or more mount interfaces. As shown in FIG. 3, one or more protrusions 14 (e.g., octagonally shaped structures similar to or the same as the protrusions 14 of the wall rail 10) may be equidistantly spaced along the exterior surface 152 of the lid 98. The protrusions 14 One or more mount interfaces may be disposed proximate to and/or adjacent to a single protrusion 14 and/or one or more mount interfaces may be defined between two or more protrusions, similar to mount interfaces of the wall rail 10 (e.g., see various mount interfaces defined in phantom/broken lines in FIG. 1).

With reference to FIGS. 4-6, the lids and/or bases (e.g., 94, 144) of the storage components described herein may define one or more mount interfaces 156 in interior and/or exterior surfaces thereof. In this way, modular accessories (i.e., described below) may mount or attach to the interior or exterior of the storage components described herein by way of interfacing with the mount interfaces, and such modular accessories also mount or attach to the wall rail. In this way, the modular accessories may be used to organize and/or store various items on the wall, in the toolbox, or both.

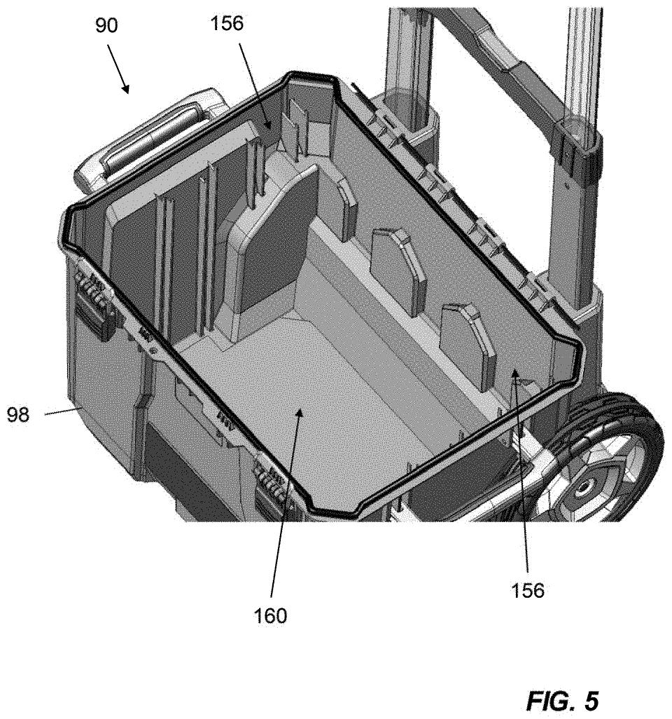

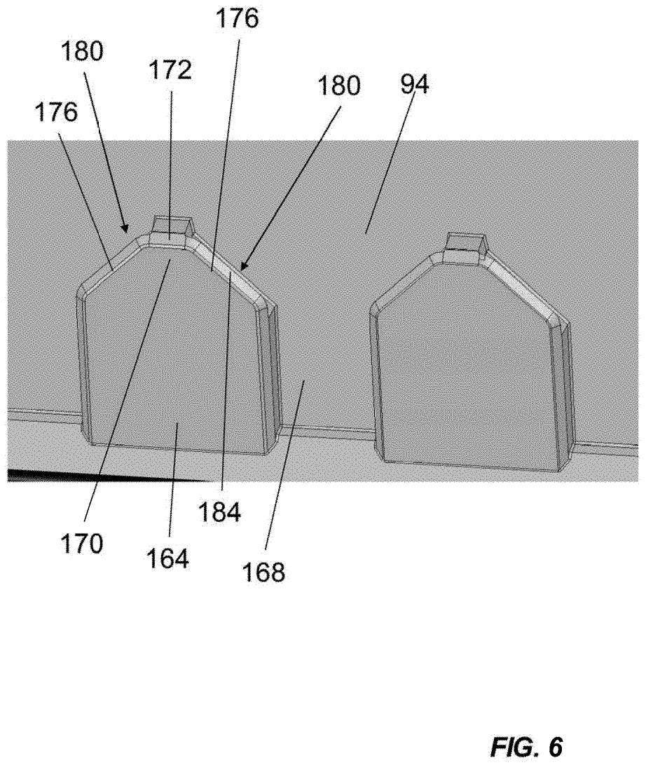

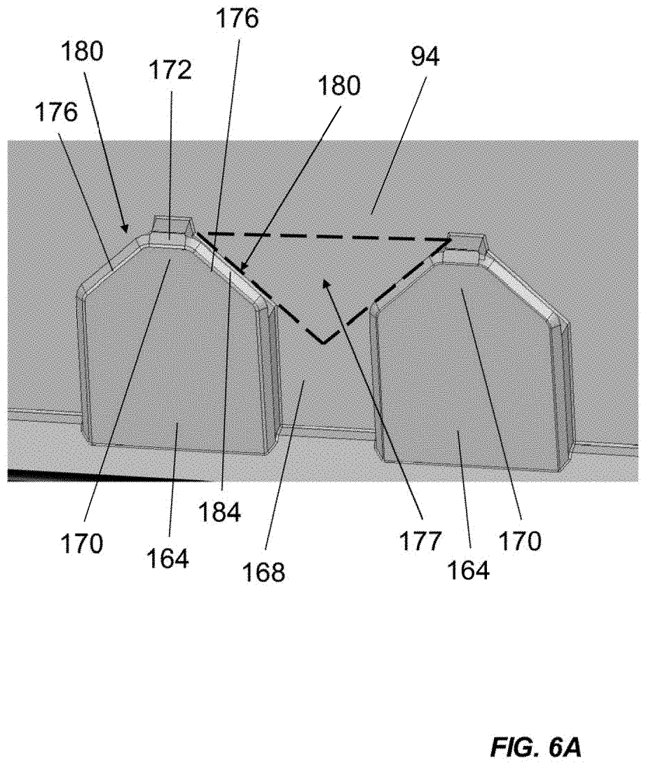

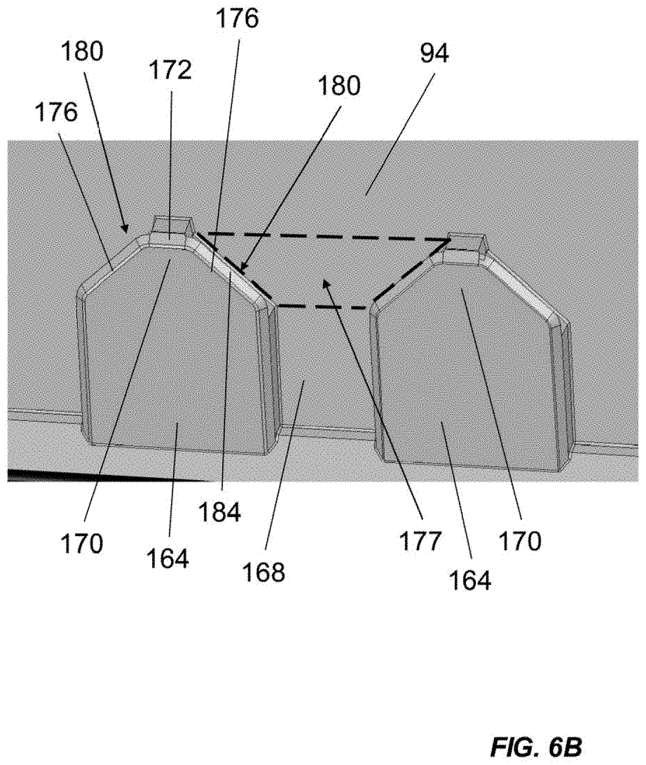

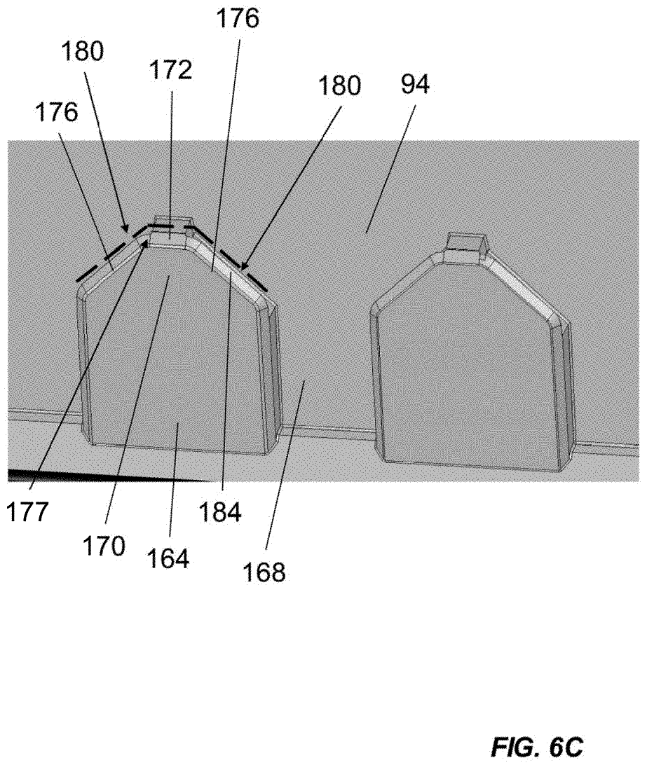

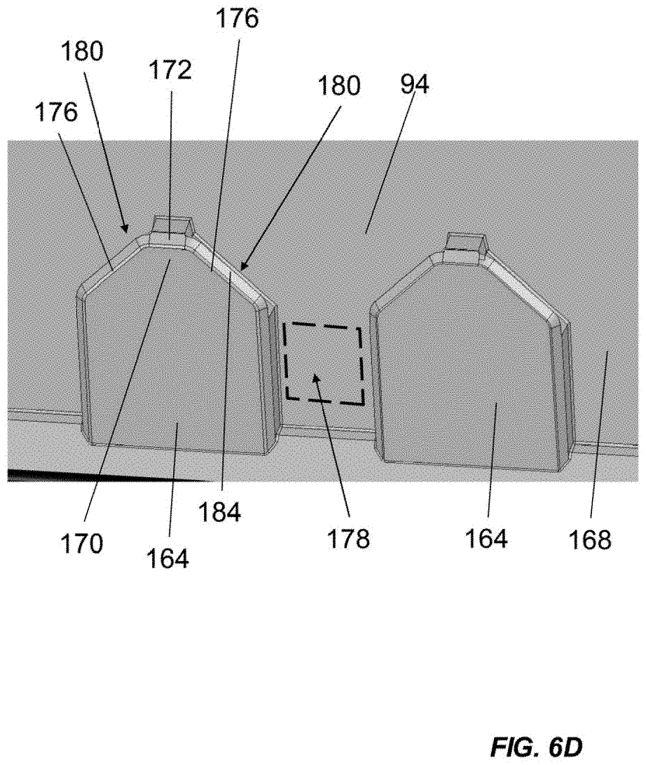

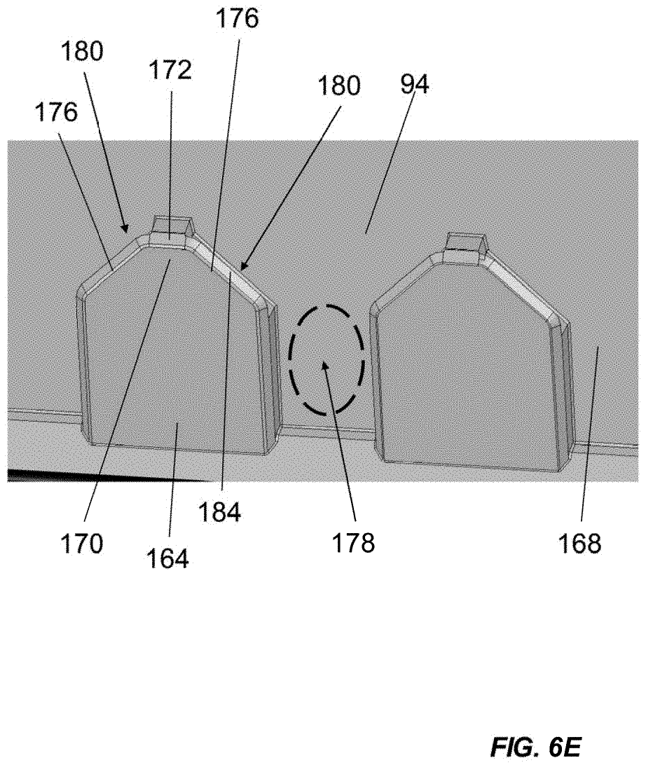

As best shown in FIGS. 5-6 and 6A-6E, the one or more protrusions 164 may extend from a surface 168 of the storage component (e.g., 90, 140). Such protrusions 164 may be formed on the lid and/or an exterior or interior side of the base. In some embodiments the protrusions 164 may include a substantially pointed upper portion 172 and angled sides 176 extending downward and away from the upper portion 172. The angled sides 176 may define undercuts 180 between an overhang portion 184 of the protrusion 164 and the surface 168 of the base. The upper portions 170 may define mount interfaces 177 similar to, for example, the second, and third mount interfaces 54A, 54B, 58 of the wall rail 10. Mount interfaces 178 may also be disposed between protrusions 164, similar to the first mount interfaces 38 described above.

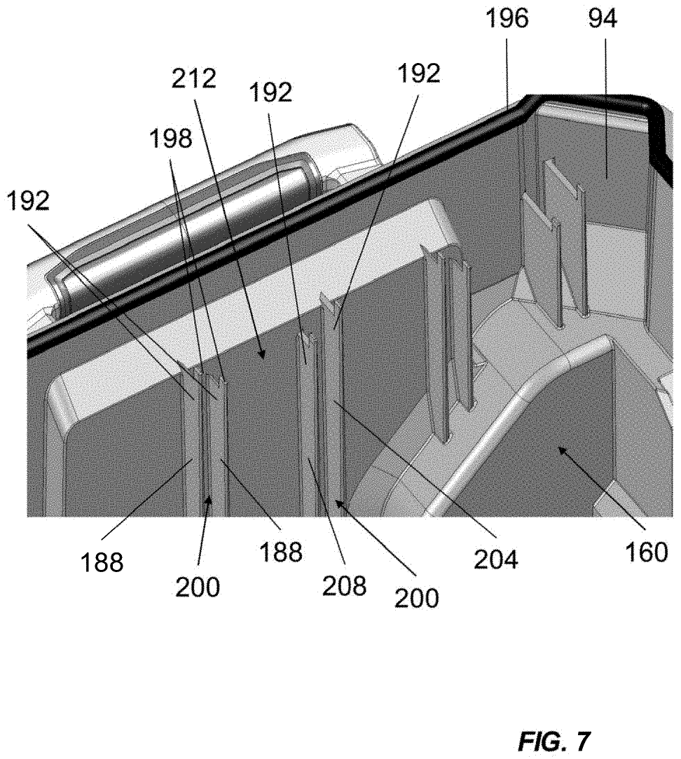

As shown in FIGS. 7 and 8, the base 94 may optionally include one or more ribs 188 disposed on the interior 160 of the base 94. Each rib 188 may include a first end 192 having a tip 198 that extends from the first end 194. The ribs 188 may be arranged in one or more pairs of ribs 200. Each pair of ribs 200 may include a first rib 204 having a first end 192 closer to the top edge 196 of the base 94 and a second rib 208 having a first end 192 further from the top edge 196 of the base 94. The pairs of ribs 200 are arranged with adjacent pairs of ribs 200 having first ribs 204 adjacent or second ribs 208 adjacent. That is, as shown in FIG. 8, the first pair of ribs 200 has a first rib 204 and a second rib 208 to the right of the first rib 204, and adjacent second pair of ribs 200 has a second rib 208 positioned closer to the second rib 208 of the first pair of ribs 200. The first ends 192 of the ribs 188 may define a mount interface 212 similar to the second mount interface 50 of the wall rail 10.

In other embodiments, the lid 98 may include one or more mount interfaces on the interior side of the lid 98, the base 94 may include mount interfaces on the exterior of the base or any combination of mount interfaces may be present on any combination of the exterior and interior of each of the base and lid.

Although various toolboxes having mount interfaces (i.e. 177, 178, 212) are shown and described in the attached figures, persons having skill in the art will appreciate that any storage component of a storage system may be provided with such mount interfaces as described herein. Such storage components may include, without limitation, rigid toolboxes, soft toolboxes, coolers, storage bins, crates, shelves, racks, cabinets, lidded enclosures, open enclosures, and/or the like.

C. Modular Accessories of a Storage System

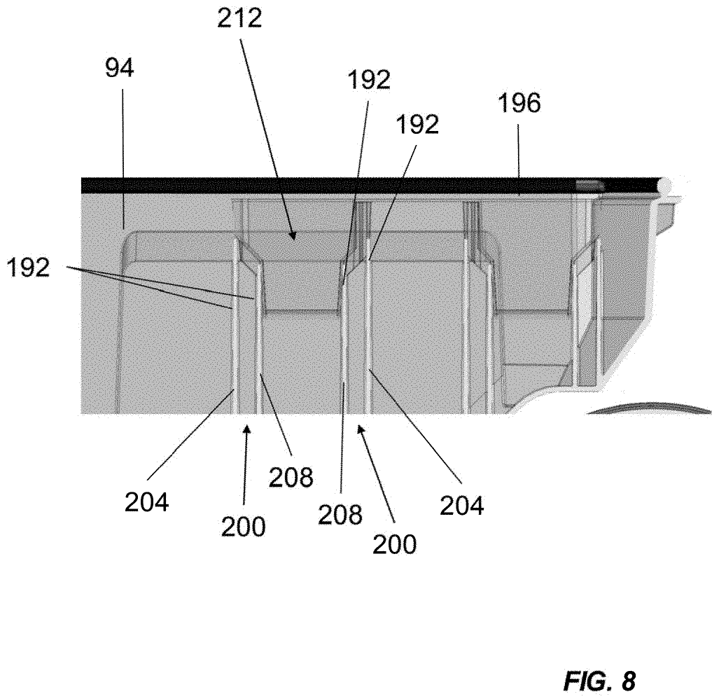

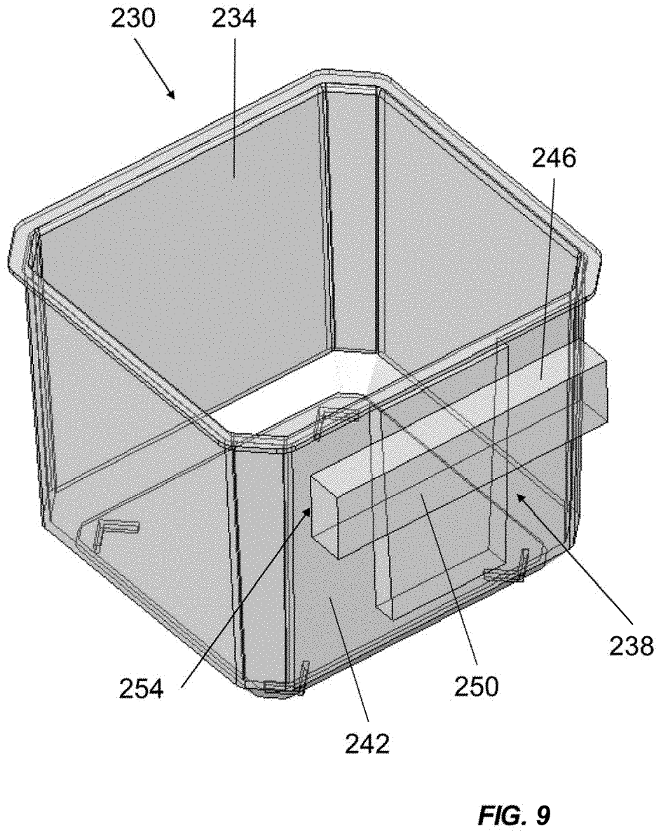

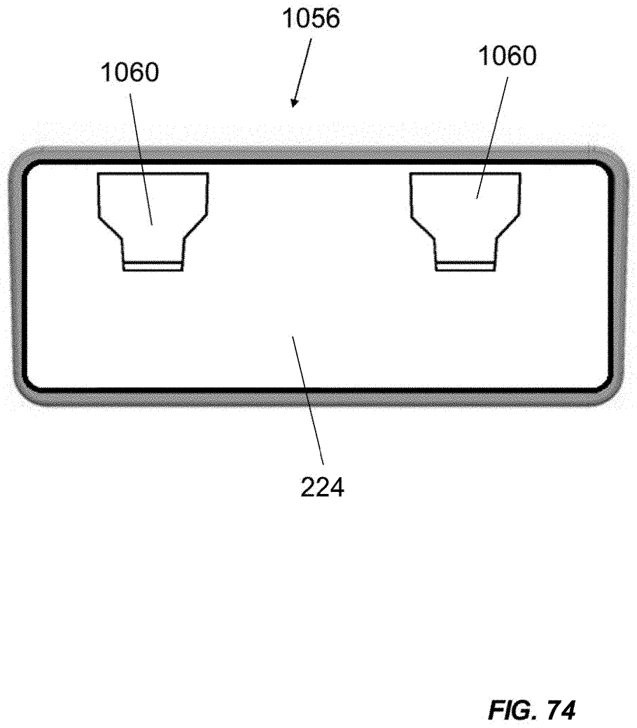

FIGS. 9-74 illustrate various embodiments of modular accessories that may be mountable to various mount interfaces of a modular storage system via an accessory mount interface. That is, the accessory mount interfaces on the modular accessories described herein can attach, interface, and/or otherwise attach to various mount interfaces disposed on the storage components of the storage systems described herein. Such storage system may include any number and/or combination of storage components, such as any number and/or combination of wall rails, toolboxes, tool bags, shelves, crates, bins, and/or the like. The modular accessories can attach to two or more storage components of the storage system.

In some embodiments, a modular accessory includes a structure, to be described in relation to specific modular accessories below, and the structure is configured to hold or support one or more objects or items (e.g., hand tools, power tools, power tool accessories, hand tool accessories, blades, batteries, paint containers, adhesive containers, and/or the like). The modular accessory may include an accessory mount, with embodiments of exemplary accessory mounts to be described hereinbelow. It will be appreciated that other embodiments of accessory mounts are contemplated. The accessory mount defines an accessory mount interface that is configured to engage one or more mount interfaces, including different mount interfaces, without modification to the accessory mount interface. In some embodiments, the accessory mount is formed monolithically with the structure. In some embodiments, the modular accessory includes a wall portion with the accessory mount extending from, and formed integrally with, the wall portion.

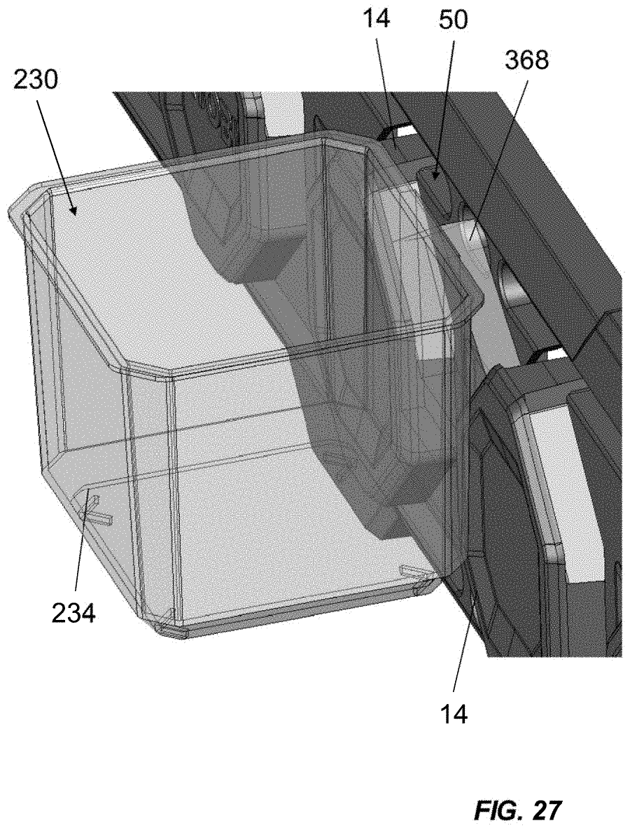

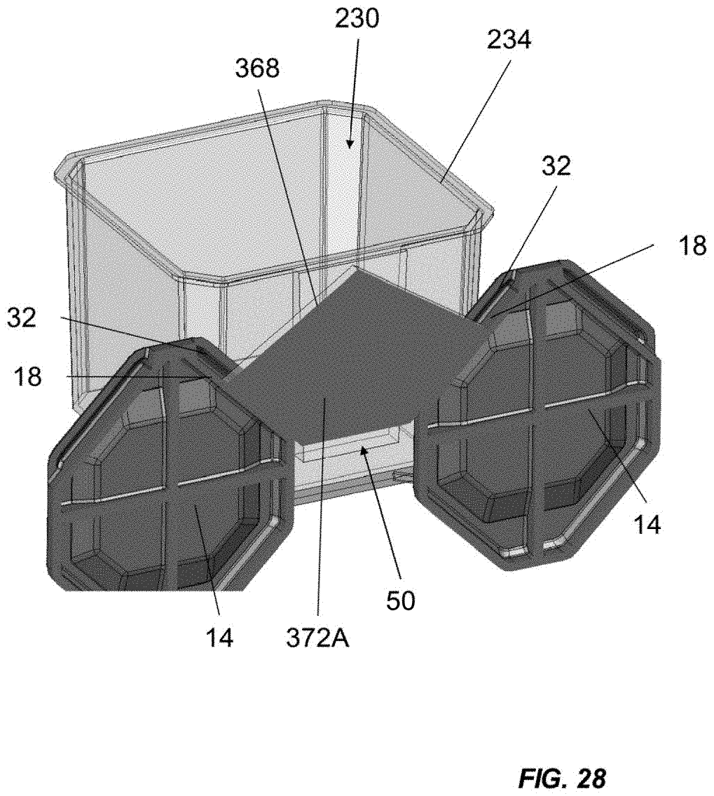

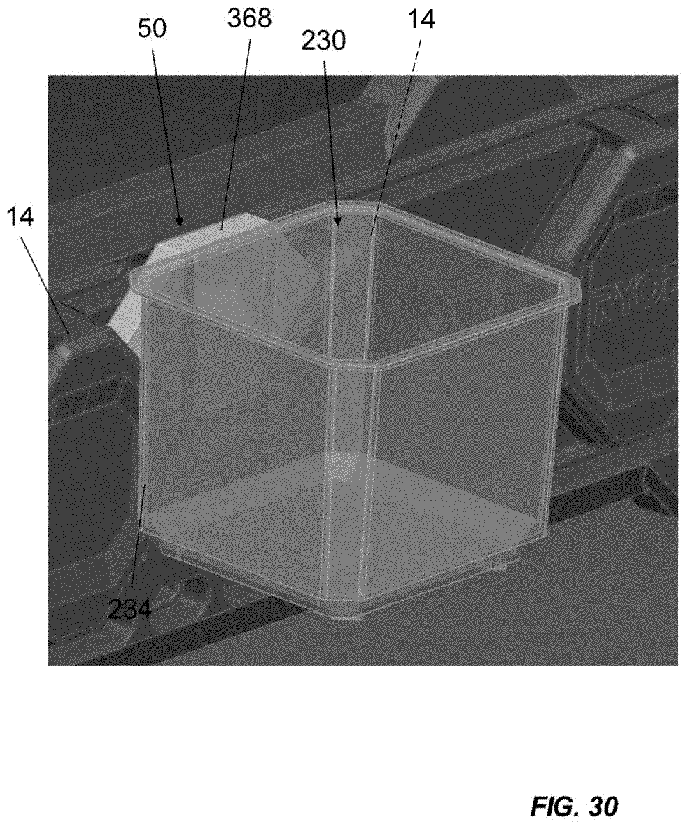

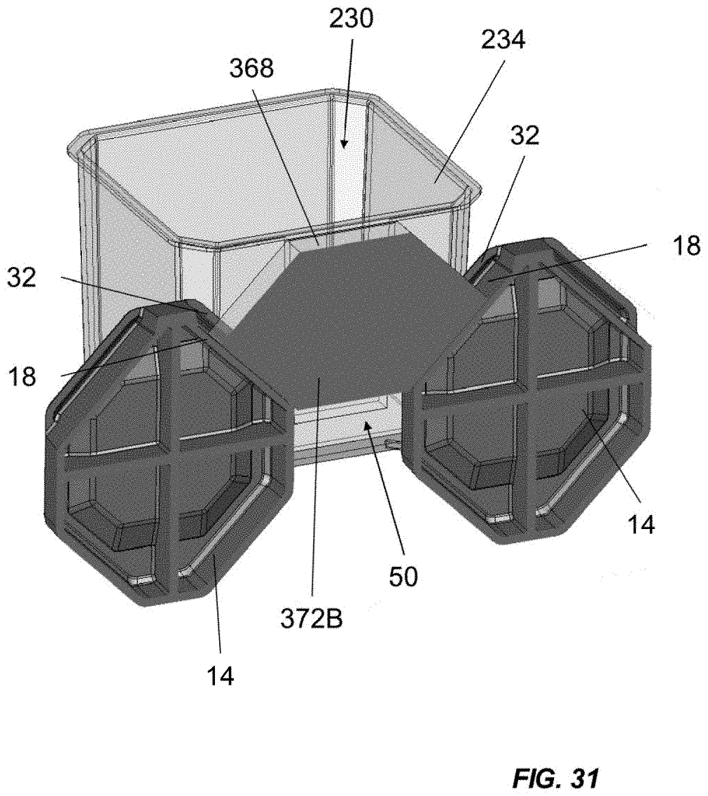

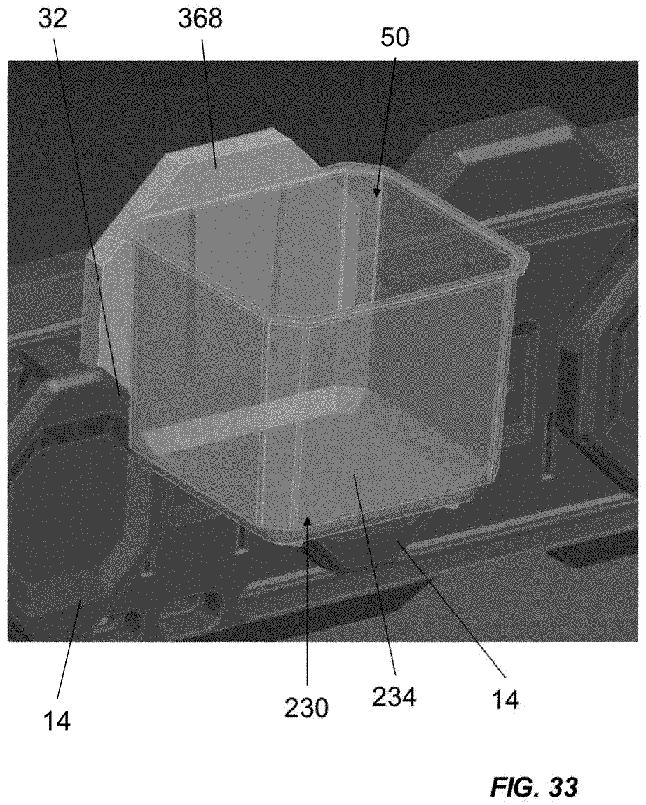

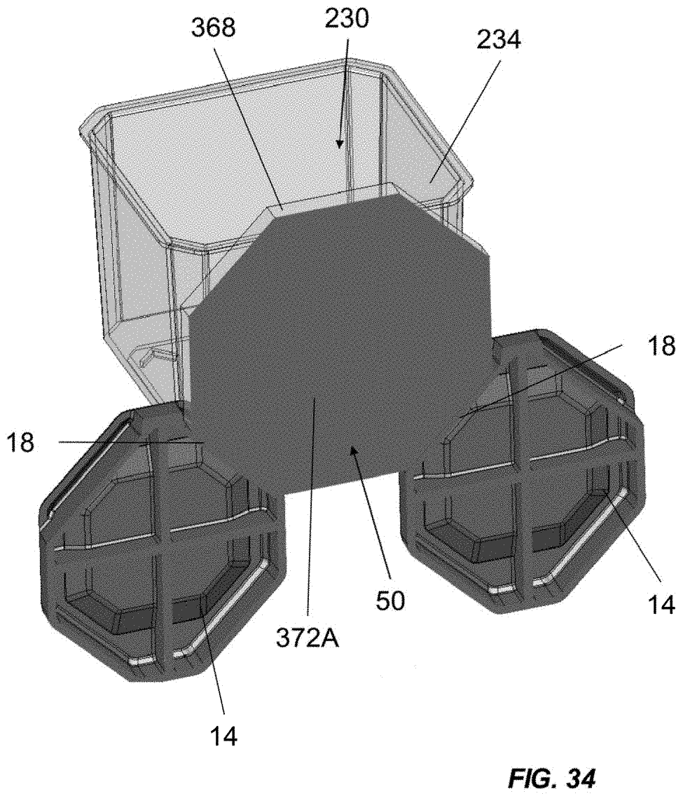

FIGS. 9-35 illustrate exemplary accessory interfaces that engage the mount interfaces for mounting an accessory to the wall rail.

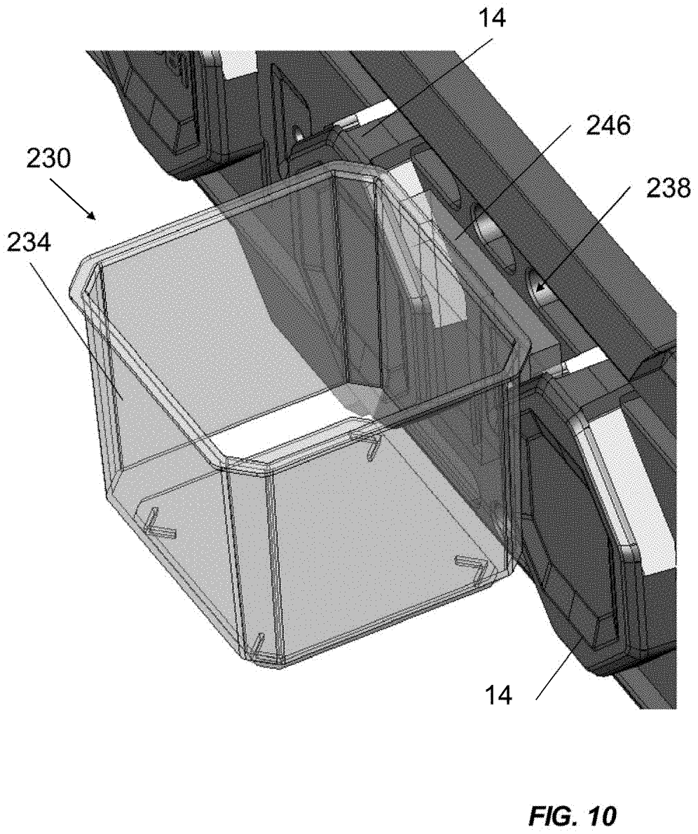

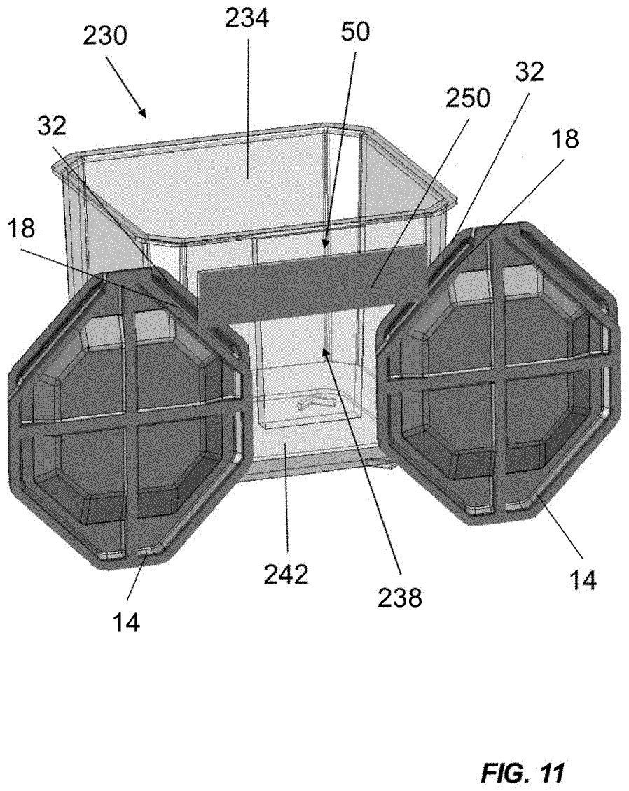

As shown in FIGS. 9-11, in one embodiment, the modular accessory is a first modular accessory 230 (e.g., a small storage bin) that may include a structure 234 and an accessory mount 238. The accessory mount 238 may extend from the rear wall 242 of the structure 234 and be formed monolithically with the structure 234. The accessory mount 238 may define an accessory mount interface 246. The illustrated accessory mount interface 246 is a first accessory mount interface having a rectangular shape (e.g., planar shape) or profile 250. The accessory mount 238 may form or define a space 254 between the accessory mount interface 246 and the rear wall 242. As shown in FIGS. 10 and 11, the accessory mount 238 may be supported by the base portions 18 of two adjacent protrusions 14 defining the second mount interface 50 and the overhang portions 32 of the protrusions 14 additionally support the accessory mount interface 246. In this way, the first modular accessory 230 may be connectable to a wall rail. In this same way, the first modular accessory 230 may be connectable to an interior or exterior surface of a storage component. For example, the accessory mount interface 246 may connect to an interior or exterior of a toolbox by way of interfacing with at least one mount interface (e.g., 177, 178, 212,) on the toolbox.

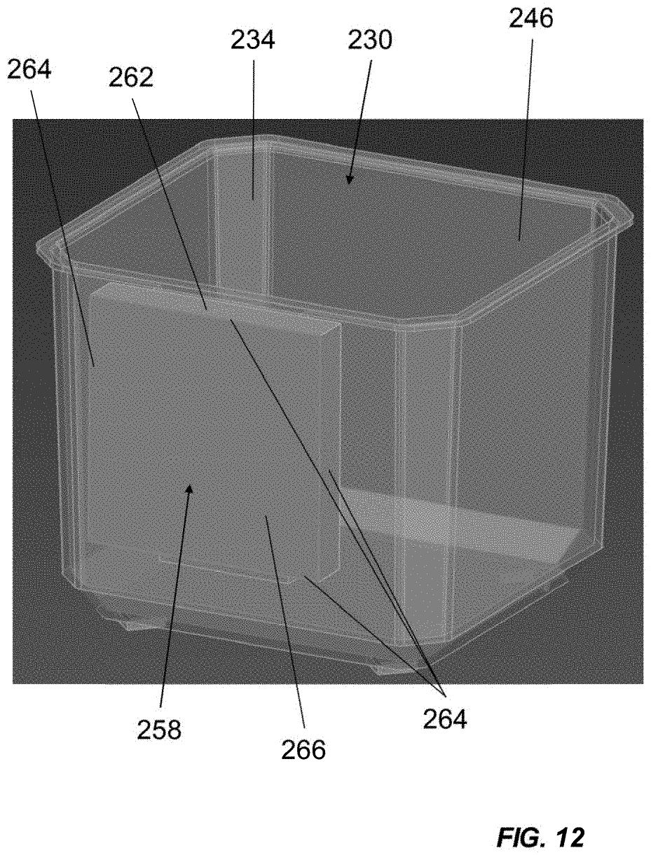

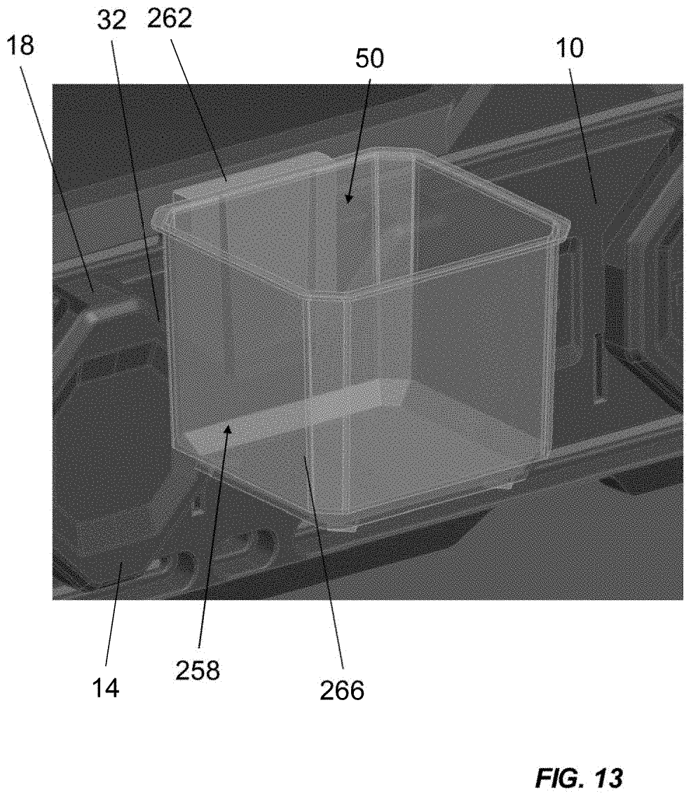

As shown in FIGS. 12 and 13, the first accessory 230 may include a second accessory mount 258 defining a second accessory mount interface 262 extending from the structure 234, with the accessory mount 258 including four edges 264 having an equal length and defining a square shape or profile 266. As shown in FIG. 13, the second accessory mount interface 262 is received in the second mount interface 50 of the wall rail 10 and is supported by the base portions 18 and the overhang portions 32 of adjacent protrusions 14. The second accessory mount interface 262 may also be received in and/or interface with the mount interfaces of other storage components described herein.

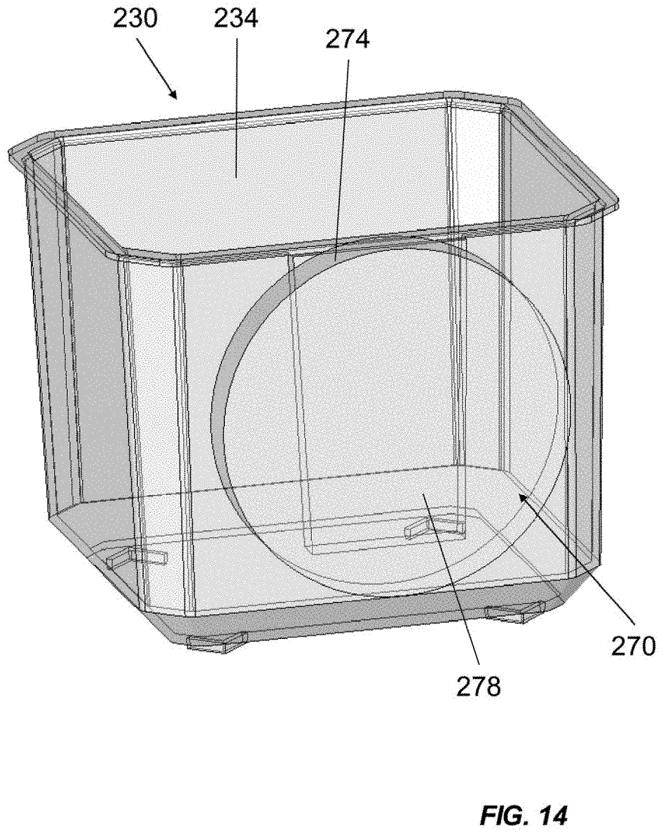

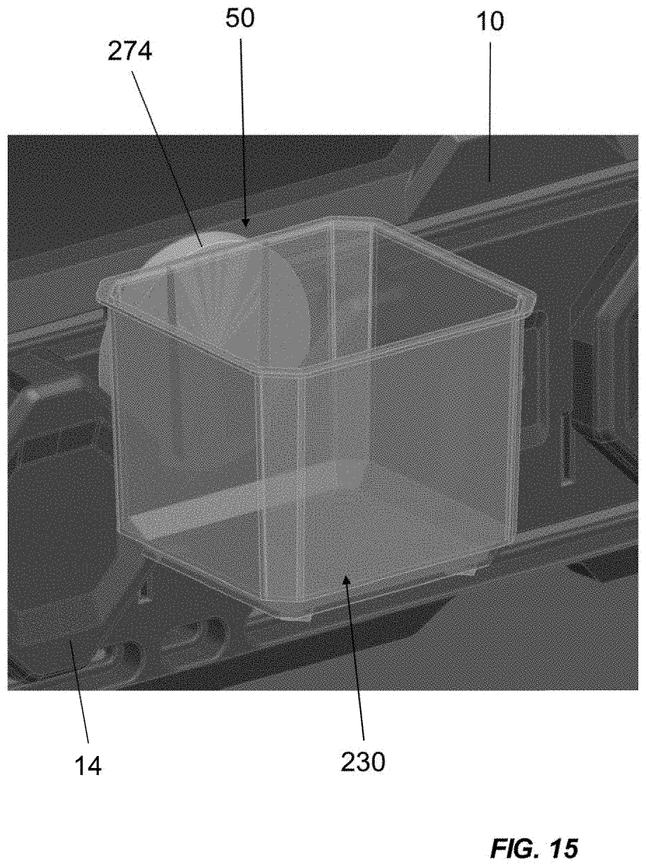

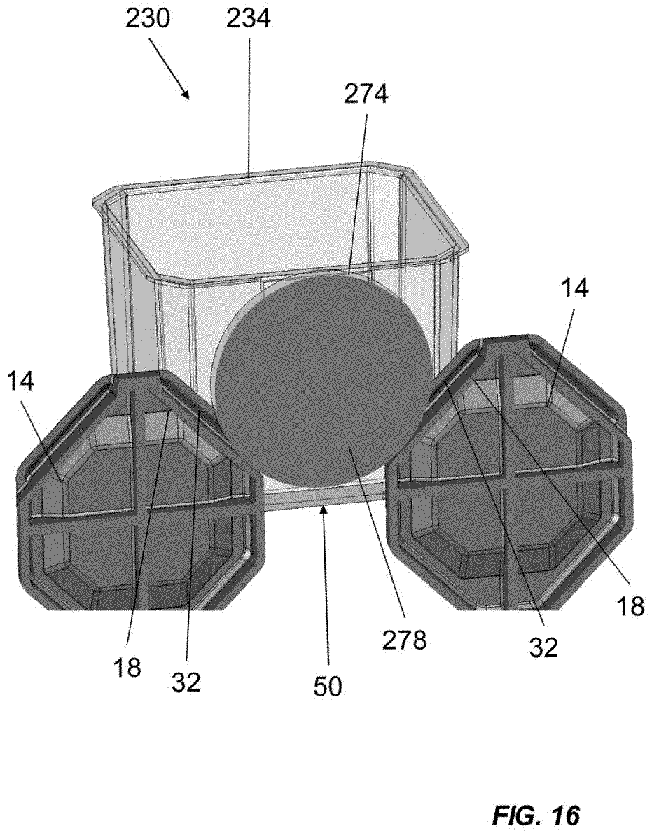

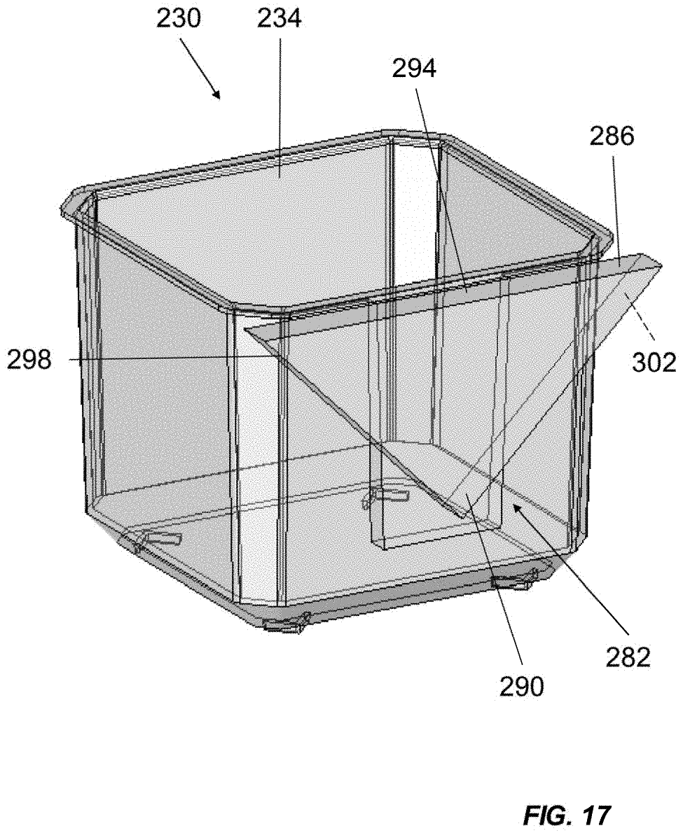

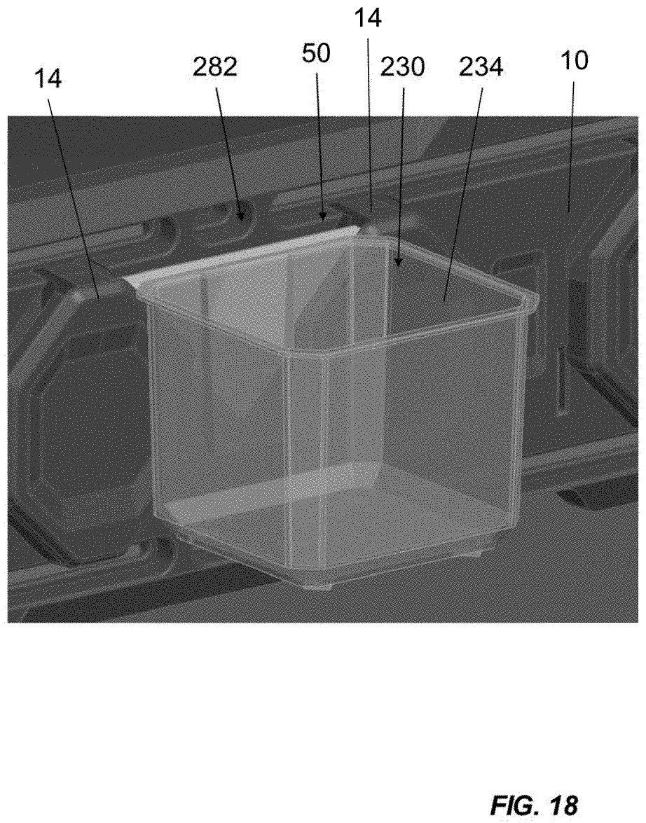

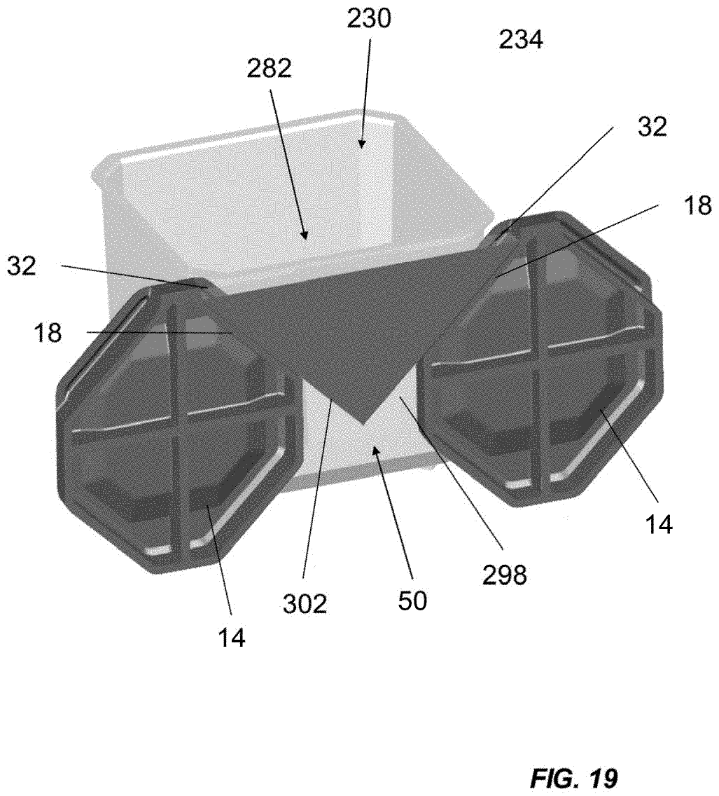

As shown in FIGS. 14-16, in another embodiment, the first accessory 230 may include a third accessory mount 270 with an edge defining a third accessory mount interface 274 having a circular shape or profile 278. As shown in FIGS. 15 and 16, the third accessory mount interface 274 is received by the second mount interface 50 of a wall rail 10 and is supported by the base portions 14 and overhang portions 32 of adjacent protrusions 14 defining the second mount interface 50. The third accessory mount interface 270 may also be received in and/or interface with the mount interfaces of other storage components described herein. As shown in FIGS. 17-19, in another embodiment, the first accessory 230 includes a fourth accessory mount 282 extending from the structure 234 and defining a fourth accessory mount interface 286 having a triangular shape or profile 290. The triangular profile 290 is arranged with a substantially horizontal surface 294 and two angled surfaces 298, 302 extending downward from the horizontal surface 294 toward the middle of the horizontal surface 294. The triangular 270 may have equivalent lengths of the surfaces 294, 298, 302 (e.g., an equilateral triangle) or may have other, unequal lengths of the surfaces. As shown in FIGS. 18 and 19, the fourth accessory mount interface 286 is supported in the second mount interface 50 of a wall rail 10 with the angled lower faces 298, 302 engaging the base portions 18 of adjacent protrusions 14. The mount portion is supported by the overhang portions 32 of the protrusions 14. The fourth accessory mount interface 282 may also be received in and/or interface with the mount interfaces of other storage components described herein.

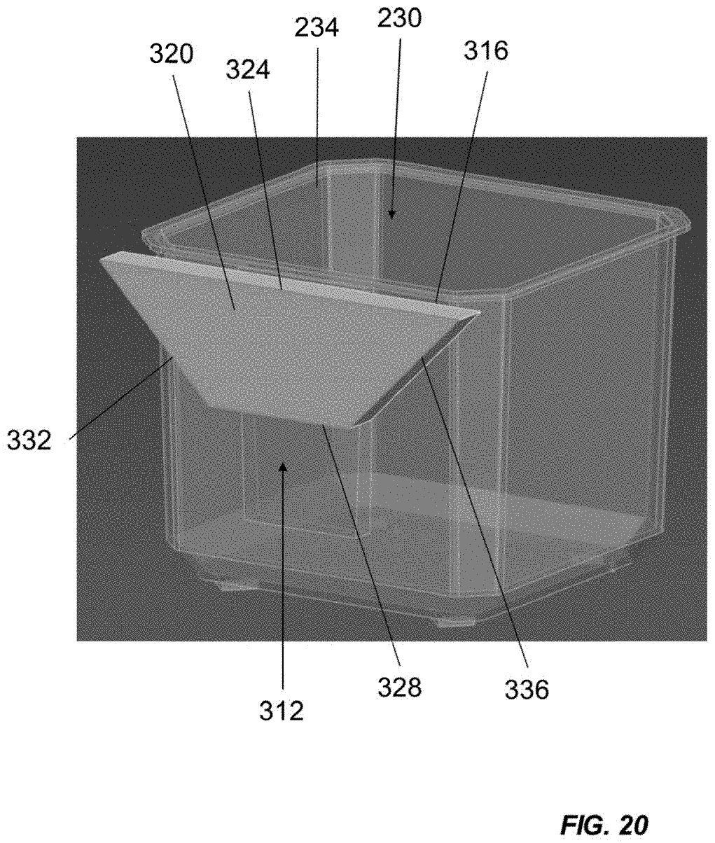

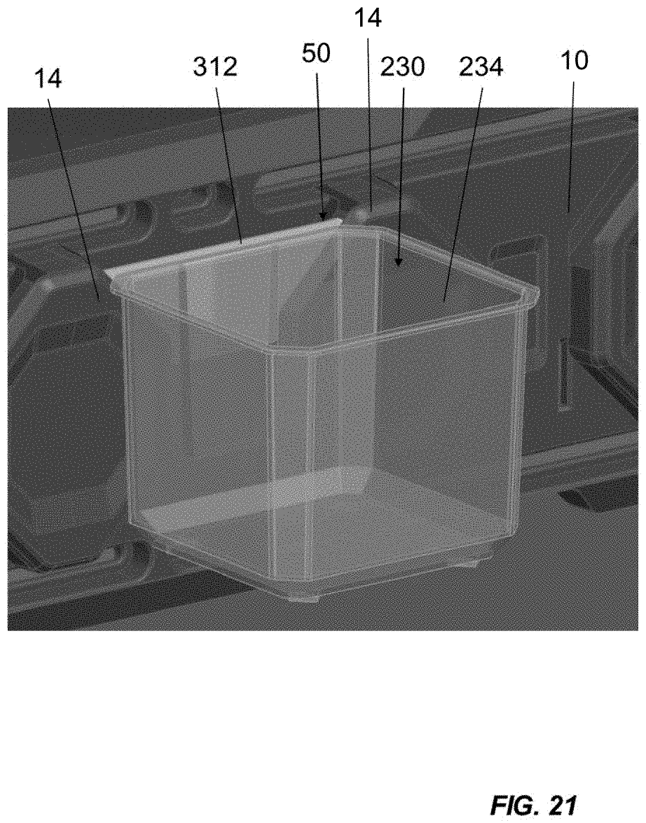

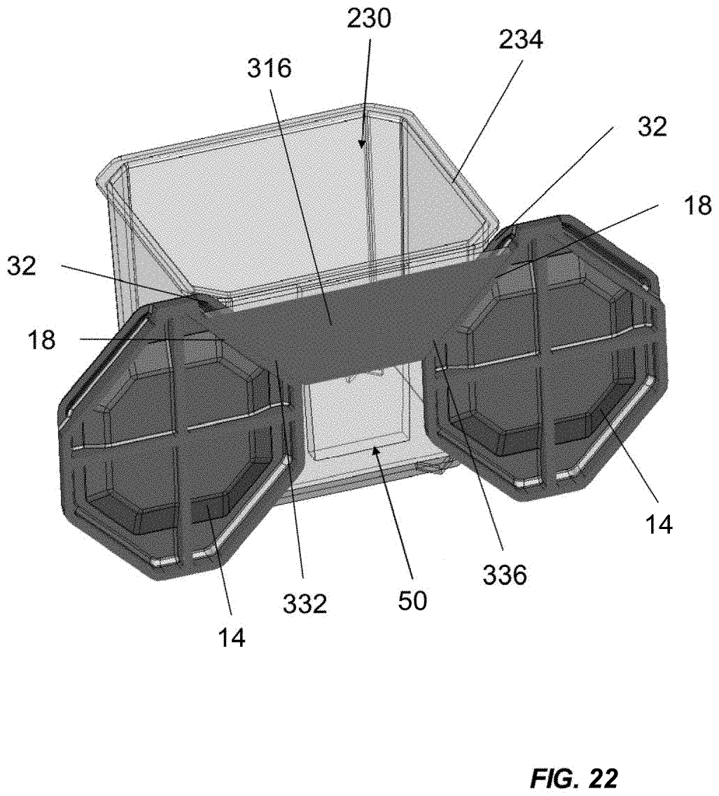

As shown in FIGS. 20-22, in another embodiment, the first accessory 230 includes a fifth accessory mount 312 defining a fifth accessory interface 316 having a trapezoidal shape or profile 320. The trapezoidal profile 320 includes a substantially horizontal upper surface 324, a substantially horizontal lower surface 328 spaced from the upper surface 324 and having a length less than the length of the upper surface, and two angled surfaces 332, 336 extending downwardly to the lower surface 328 and inward toward the middle of the upper surface 324. As shown in FIGS. 21 and 22, the fifth accessory mount interface 316 of the fifth accessory mount 312 is received in a second mount interface 50 of a wall rail 10. The angled surfaces 332, 336 are supported by the base portions 18 and overhang portions 32 of adjacent protrusions 14. The fifth accessory mount interface 316 may also be received in and/or interface with the mount interfaces of other storage components described herein.

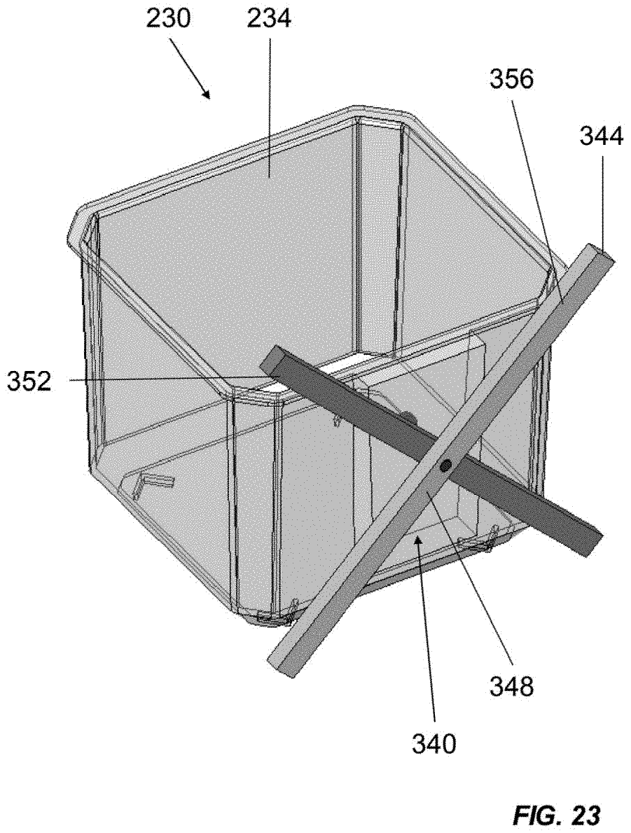

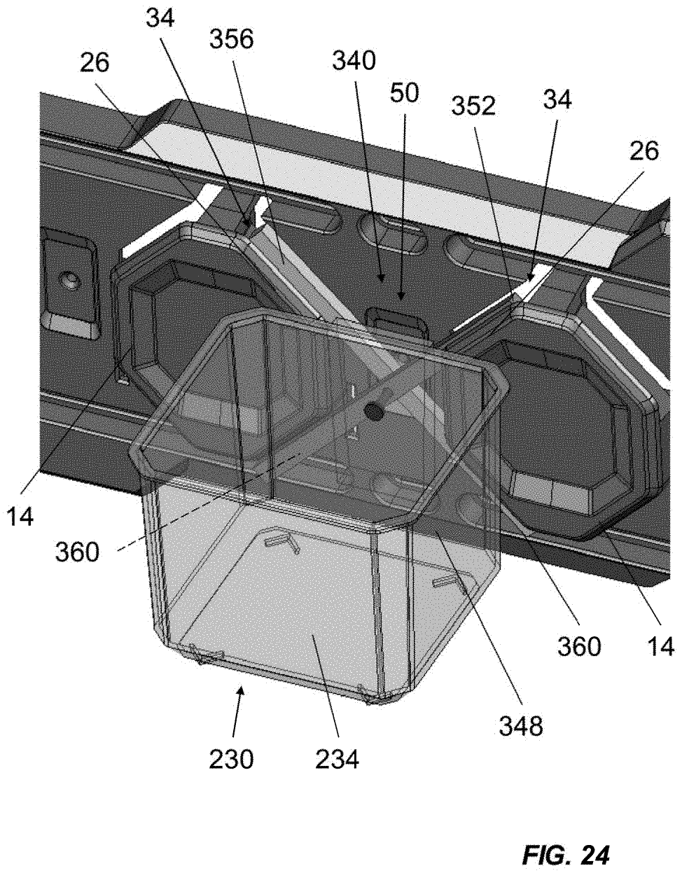

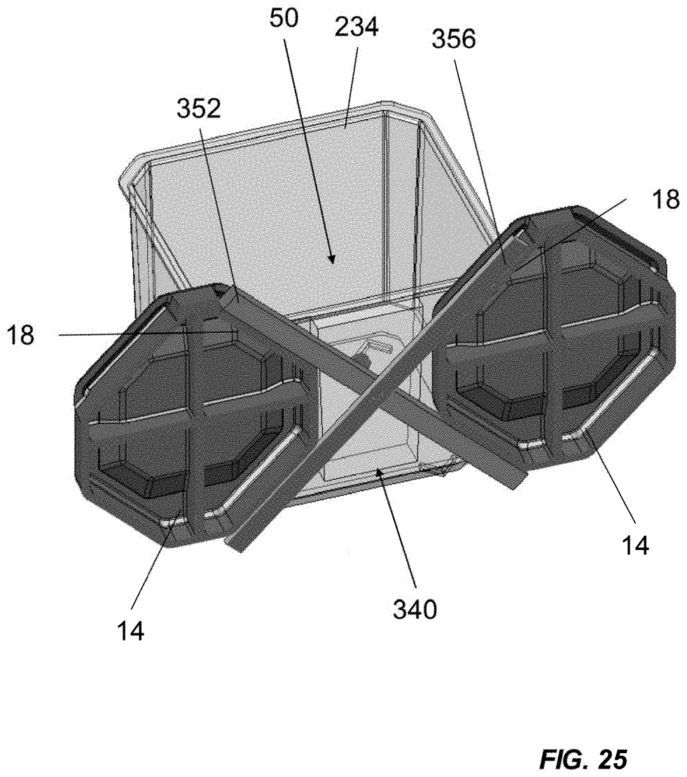

As shown in FIGS. 23-25, in another embodiment, the first accessory 230 includes a sixth accessory mount 340 defining a sixth accessory mount interface 344 having an X-shaped or cross profile 348. The sixth accessory mount 340 includes a first and second bar 352, 356 coupled together to define the X-shaped profile 348, although the first and second bars 352, 356 may be formed integrally. In some embodiments, the first and second bars 352, 356 include a biasing member (e.g., a spring, a clip, and/or the like) disposed therebetween that allows the X-shape to be collapsed for insertion against a mount interface on a wall rail or storage component, and then expand and lock into place against the wall rail or the storage component. The first bar 352 may be perpendicular to the second bar 356 or positioned at another angle. As shown in FIGS. 24 and 25, the first and second bars 352, 356 may be partially received in the second mount interface 50, that is, in the undercuts 34 of adjacent protrusions 14 with lower portions 360 of the first and second bars 352, 356 positioned adjacent lower angled portions 26 of the protrusions 14. The first and second bars 352, 356 may be partially supported by the base portions 18. In other embodiments, the lower portions 360 of the first and second bars 352, 356 may be received in the undercuts 34 of one protrusion 14 and supported by the upper angled portions 26 of the protrusion 14, and the upper portions of the first and second bars 352, 356 supported by a protrusion 14 of a wall rail 10 positioned vertically adjacent the wall rail 10. The sixth accessory mount interface 344 may also be received in and/or interface with the mount interfaces of other storage components described herein.

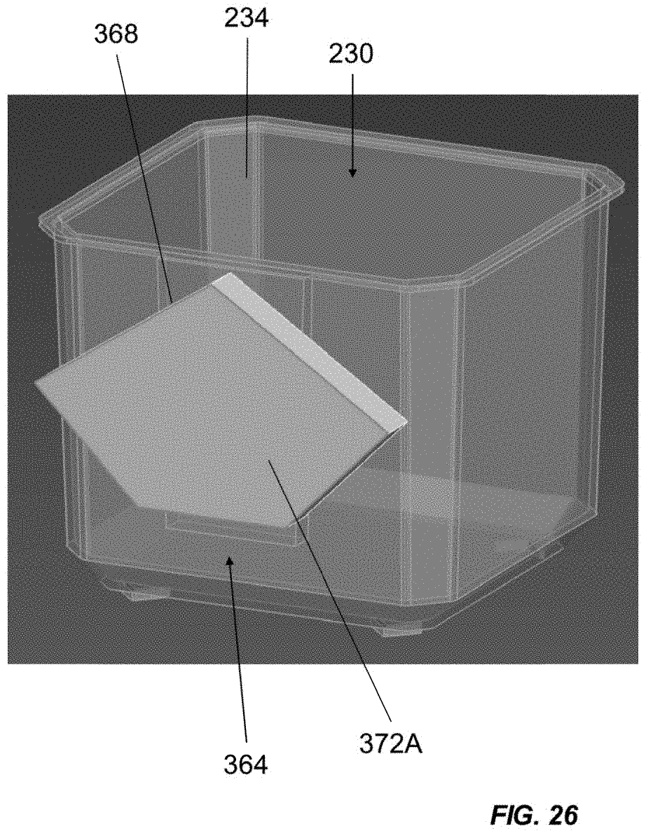

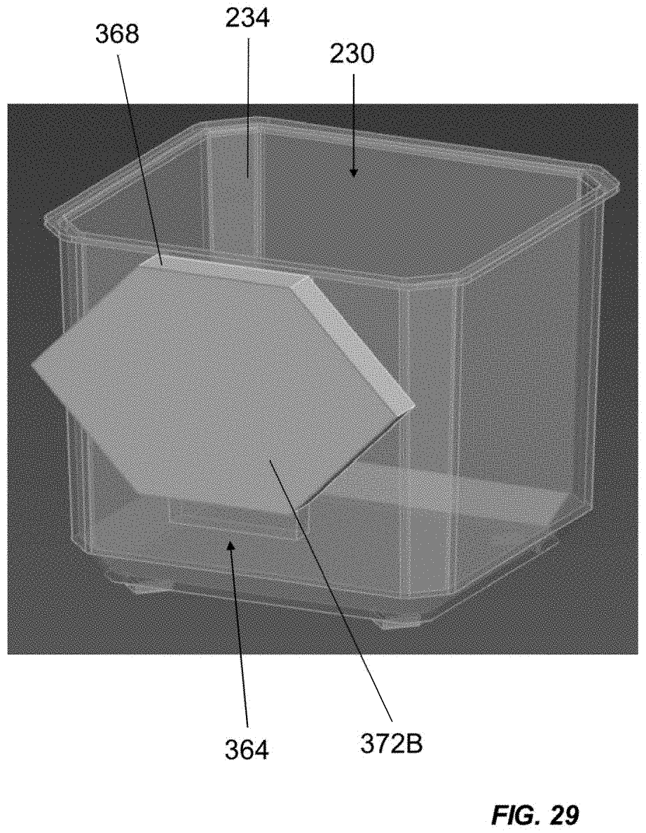

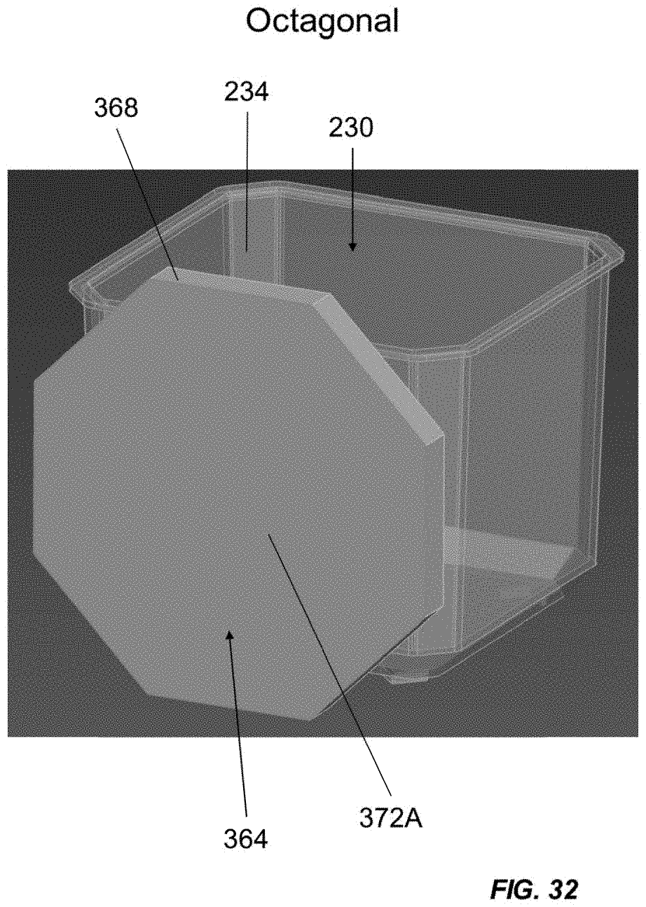

FIGS. 26-34 illustrate other embodiments of a first accessory 230 including a seventh accessory mount 364 with edges defining a seventh accessory mount interface 368 having a polygonal shape or profile 372, such as a pentagonal profile 372A (FIGS. 26-28), a hexagonal profile 372B (FIGS. 29-31), or an octagonal profile 372C (FIGS. 32-34), although other polygonal profiles may be used. The seventh accessory mount interface 368 may be received in the second mount interface 50 of a wall rail 10 and are supported in the undercuts 34 of adjacent protrusions 14 by the base 18 and the overhang portions 32 of adjacent protrusions 14. The seventh accessory mount interface 364 may also be received in and/or interface with the mount interfaces of other storage components described herein.

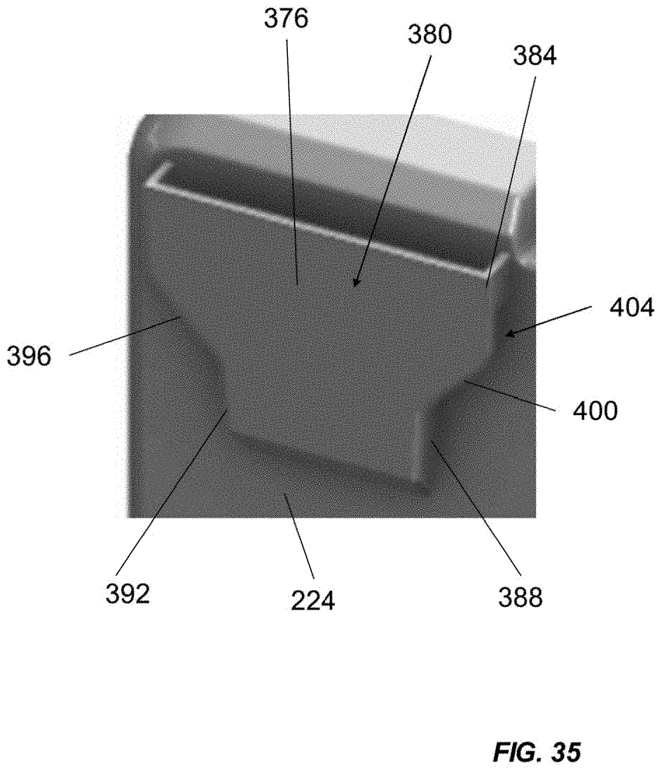

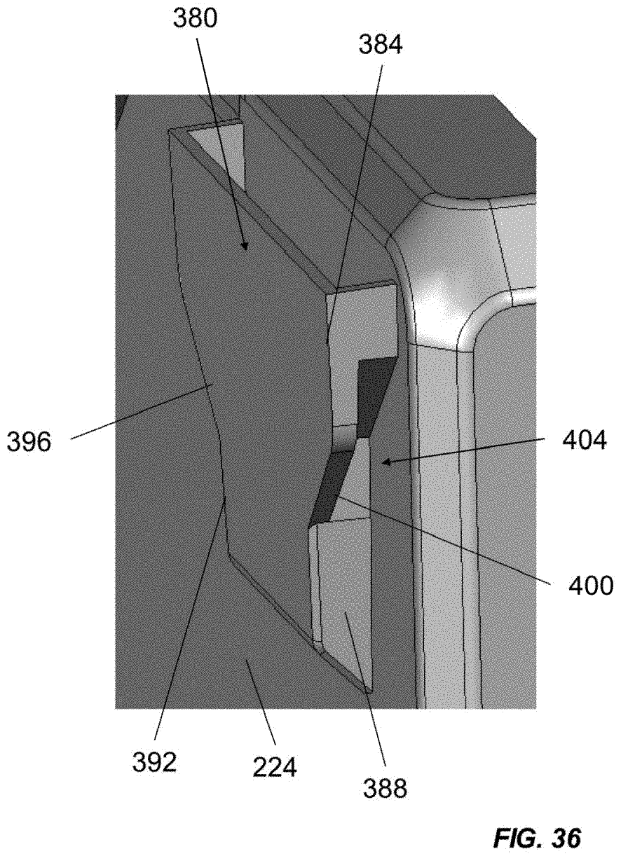

As shown in FIGS. 35 and 36, in another embodiment, an accessory having a rear wall 224 includes an eighth accessory mount 376 defining an eighth accessory mount interface 380 having a Y-shape or profile 384. The eighth accessory mount interface 380 may include a pair of spaced, substantially vertical portions 388, 392, with an angled portion 396, 400 extending from each vertical portion 388, 392. The angled portions 396, 400 extend away at an angle from one another thereby defining the Y profile 384. An undercut 404 is defined by the Y profile 384 between the vertical and angled portions 388, 392, 396, 400 and the rear wall 224 of the accessory. The eighth accessory mount interface 380 may also be received in and/or interface with the mount interfaces of other storage components described herein.

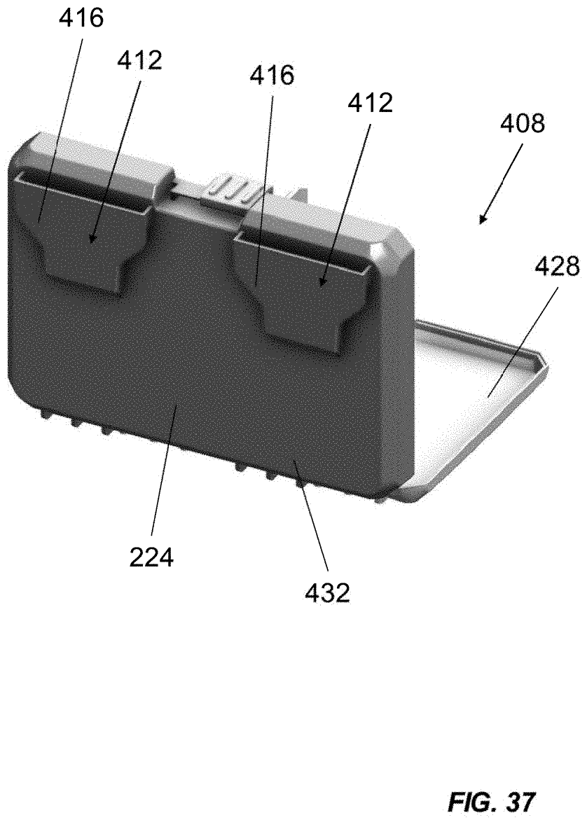

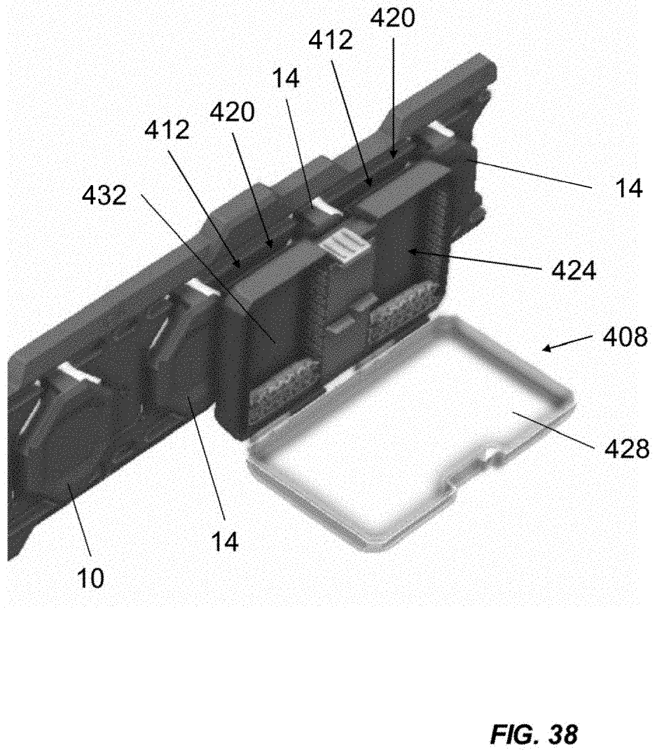

FIGS. 37 and 38 illustrate a second accessory 408 (e.g., a small accessory case) including two accessory mounts 412 embodied as eighth accessory mounts 376, each defining an accessory mount interface 416 coupled to a wall rail 10 (FIG. 38). Each accessory mount interface 416 may be received in a mount interface 420, illustrated as a second mount interface 50, of the wall rail 10. As illustrated in FIG. 38, the accessory mount interfaces 416 may be supported in the mount interfaces 420 of the wall rail 10.

In another embodiment of the accessory interface, the accessory interface may include a mount portion that encompasses a protrusion defining the fifth mount interface and engages the overhang portions. An accessory including the accessory interface may be rotatable relative to the protrusion and the wall rail while maintaining engagement with the fifth mount interface.

Any of the above-described accessory interfaces are interchangeable with other accessory interfaces and can be included with any of the following accessories.

FIGS. 37-40 illustrate the second accessory 408, or accessory case. The accessory case 408 may define a compartment 424 (e.g., for holding or storing drill bits or fastener tools) that is enclosed by a lid 428 defining a front side 432 of the accessory case 408. The lid 428 may be clear (transparent) or opaque. The accessory case 408 also includes a base 432 that defines the rear wall 224, and the lid 428 is pivotable relative to the base 432 between the open position (FIG. 38) and a closed position (not shown). A latch 436 is supported on the base 432 and is slidable relative to the base 432 and the lid 428 to couple the lid 428 to the base 432 in the closed position. When the accessory case 408 is coupled to a storage system, the contents of the accessory case 408 are accessible for removal, use, and replacement by pivoting the lid 428 to the open position.

As shown in FIG. 37, the accessory case may include two accessory mounts 412 (two accessory interfaces shown in FIG. 37) on the extending from the rear wall 224 that facilitate removably mounting the accessory case 408 to two corresponding mount interfaces 420 of a wall rail 10 (FIG. 38) or storage bin (FIG. 4) or other component of a storage system. As illustrated, each accessory mount interface 412 may be an eighth accessory mount interface to snugly and removably fit the mount interfaces 420 defined between adjacent protrusions 14 of the wall rail 10.

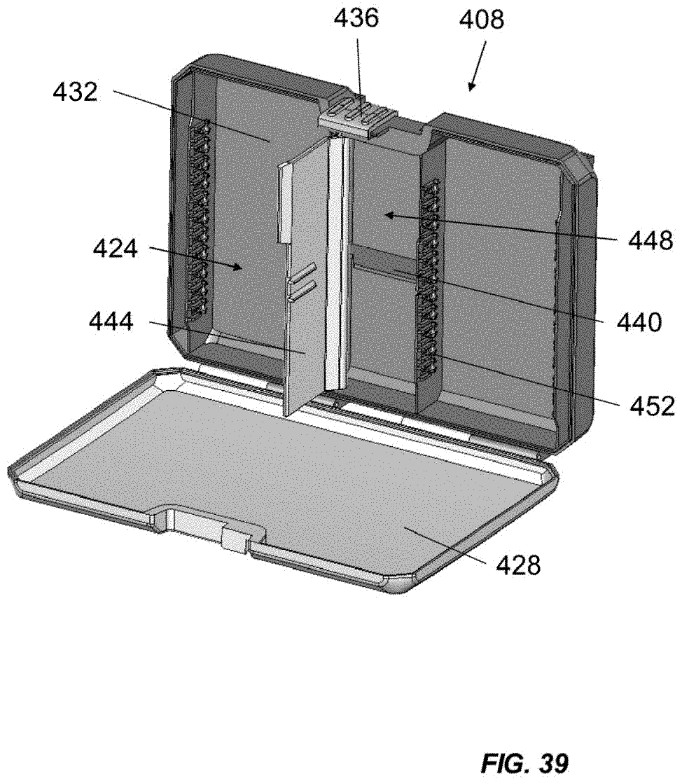

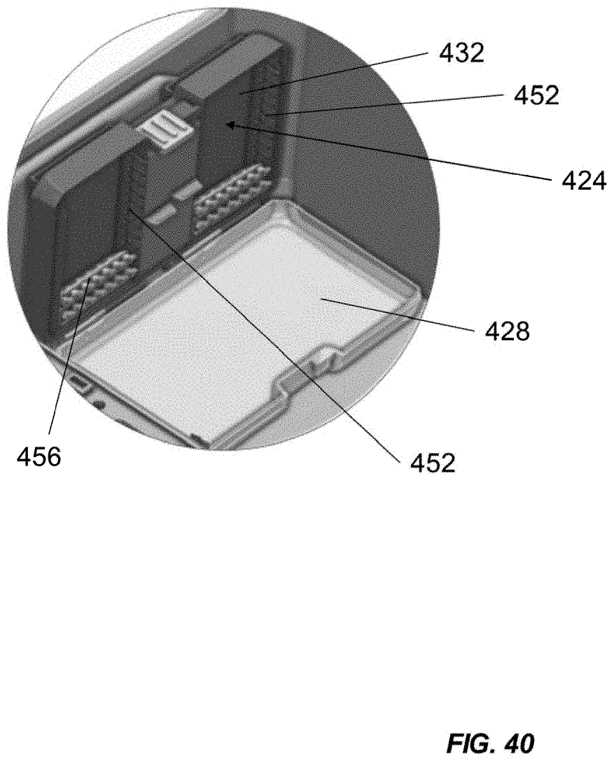

As shown in FIG. 39, a partition 440 may be supported in the compartment 424. The compartment 424 may include an inner lid 444 pivotally coupled to the base 432 to enclose an inner compartment 448. The compartment 424 may include a plurality of installation locations 452 that, as best seen in FIGS. 39 and 40, support a bit bar 456 defining holes in which various bits 464 are disposed. The holes may be identically sized, or uniquely sized to support different diameter bits. In other embodiments, the accessory case may receive a holder for router bits, a hole saw set, a Forstner bit set, a spade bit set, a tap set, a step bit set, a socket set, or other bits for a drill/driver. In still other embodiments, the holder for any of the above-mentioned bits may be formed integrally with the base or the lid, with the lid preventing the cutting side of the bit from cutting or otherwise damaging other contents of the storage box. The compartment 120 may provide storage for loose items. In still other embodiments, the accessory case may be configured as a first aid kit.

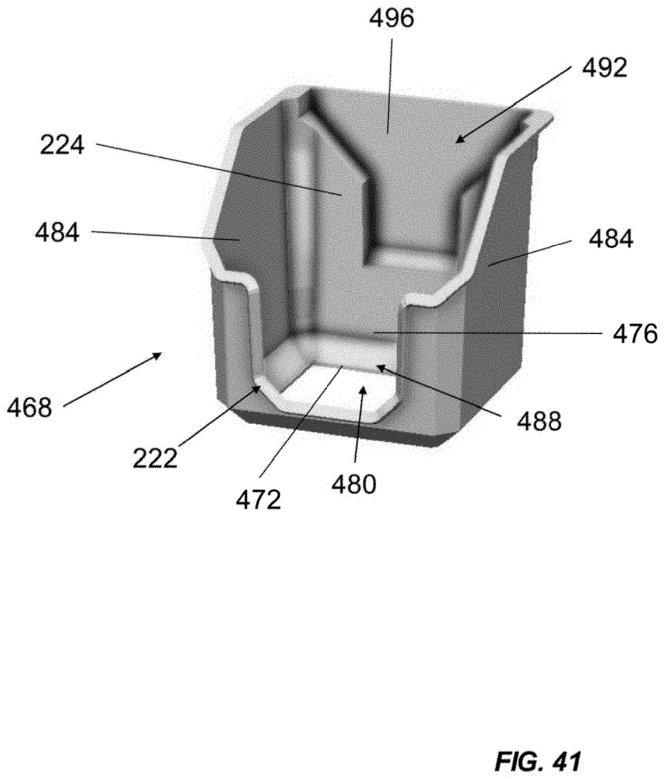

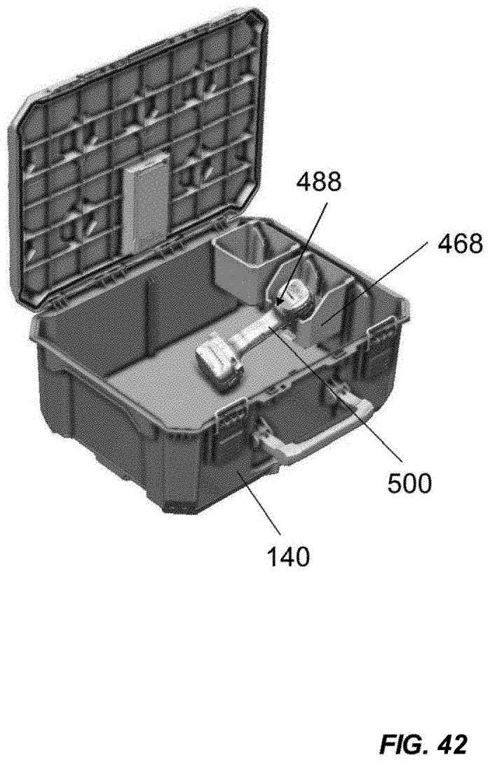

FIGS. 41 and 42 show a third modular accessory 468, or a tool holster (e.g., coupled to a toolbox 140). The tool holster 468 may include a substantially horizontal shelf 472 extending from a lower edge 476 of the rear wall 224, a hole 480 through the horizontal shelf 472, and vertical side walls 484 that meet at the front and that cooperatively define a pocket or recess 488. An accessory mount 492 defining an accessory mount interface 496 extends from the rear wall 224 (e.g., an eighth accessory mount interface) for removable attachment to a mount interface of a storage system, consistent with what is described above. As shown in FIG. 42, an object, such as a tool 500 can be supported by the tool holster 468 (e.g., in a toolbox 140). For example, the forward part of the tool 500 (e.g., a battery-powered drill) can extend through the hole 480 and the body of the tool 500 extends outward from the tool holster 468 though the recess 488. The tool holster may be a rigid part that is formed to at least partially conform to the body (e.g., the motor housing or the battery attachment portion) of a tool (e.g., a hand tool or power tool) and include an accessory interface integrally formed with the tool holster. The tool holster is illustrated as a having rigid walls but may instead be a soft good constructed of cloth, nylon, canvas, polyester, or other non-rigid material.

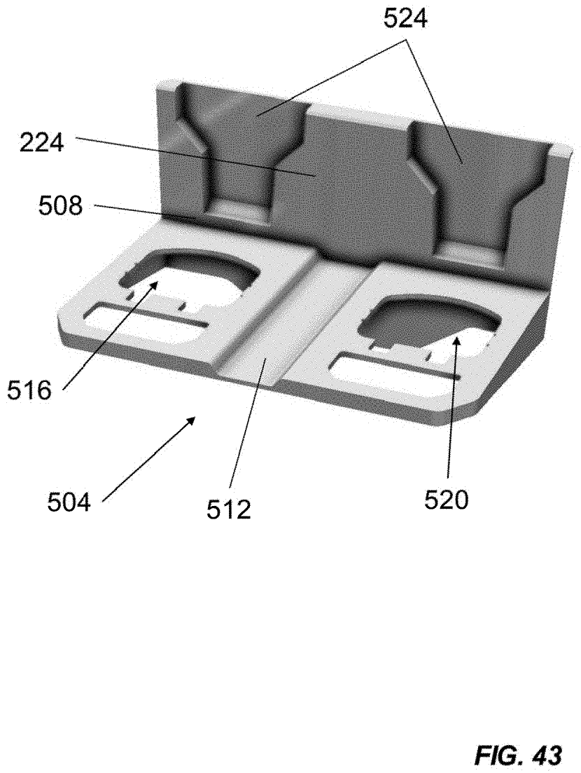

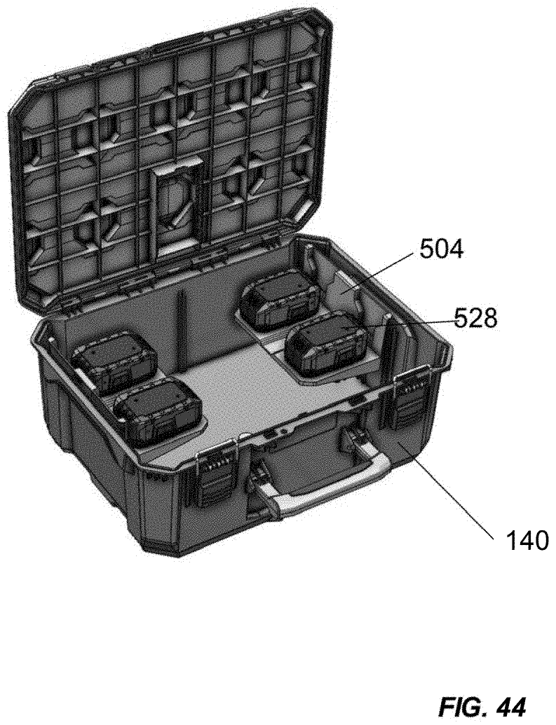

FIGS. 43 and 44 illustrate a fourth modular accessory, or a battery holster 504. The battery holster 504 may include a rear wall 224 with a lower edge 508 from which a horizontal shelf 512 with holes 516, 520 extends. The rear wall 224 may have an accessory mount 524 (e.g., eighth accessory mount 376) that defines an accessory mount interface for removable attachment to a mount interface (e.g., second mount interface 50) of a storage system, consistent with what is described above. As shown in FIG. 44, one or more batteries and/or battery packs 528 can be supported by the battery holster 504 (e.g., in the toolbox 140) by at least partially aligning and/or inserting the battery pack 528 into the holes 516, 520 so that the battery pack(s) remain on the battery holster 504 until it is desired for removal. The illustrated battery holster 504 has two accessory mounts 524 and is designed to support two battery packs 528, although it will be appreciated that the battery holster 504 may be designed to support any quantity of battery packs.

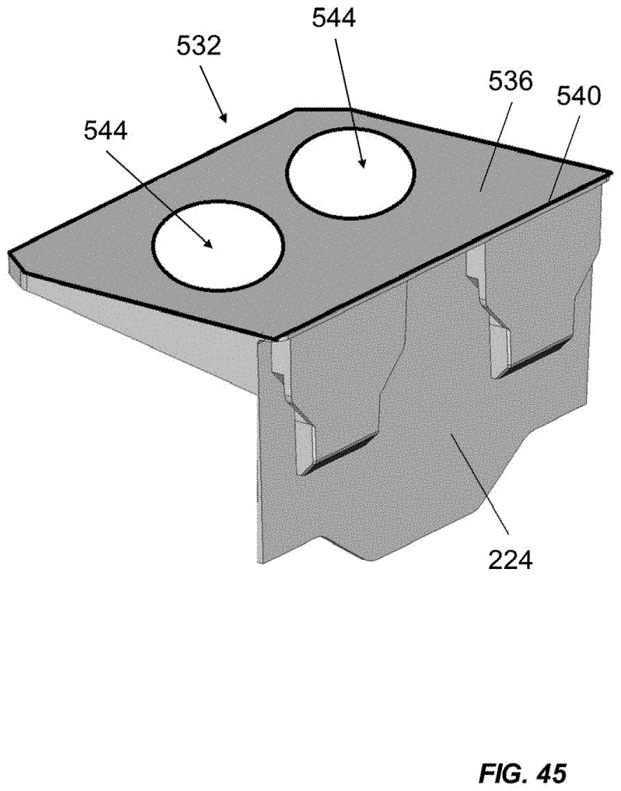

FIG. 45 illustrates a fifth modular accessory 532, or a top tray. The top tray 532 has a horizontal shelf 536 extending from the top edge 540 of the rear wall 224 of the top tray 532. The horizontal shelf 536 includes holes 544 (two holes shown although other quantities may be included) which receive various hand tools (e.g., screwdrivers, wrenches, etc.). The rear wall 224 includes at least one accessory mount (for instance, eighth accessory mount interface) for removable attachment to a mount interface of a storage system (e.g., a wall rail 10).

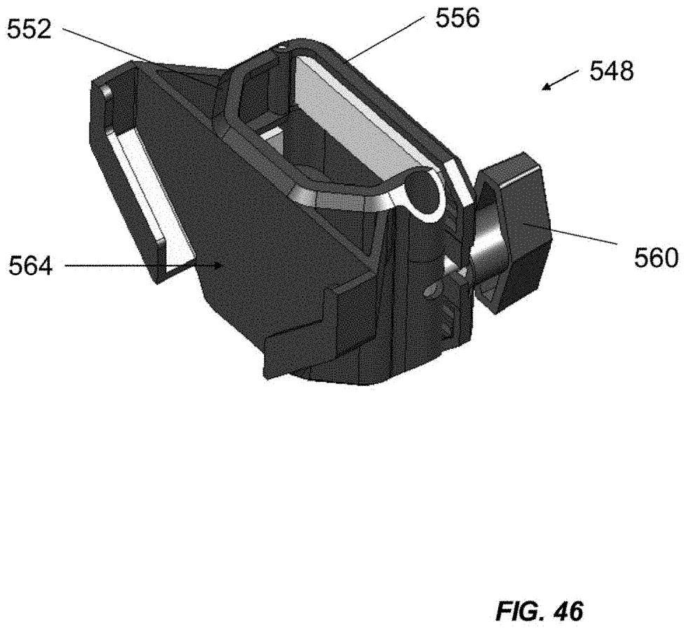

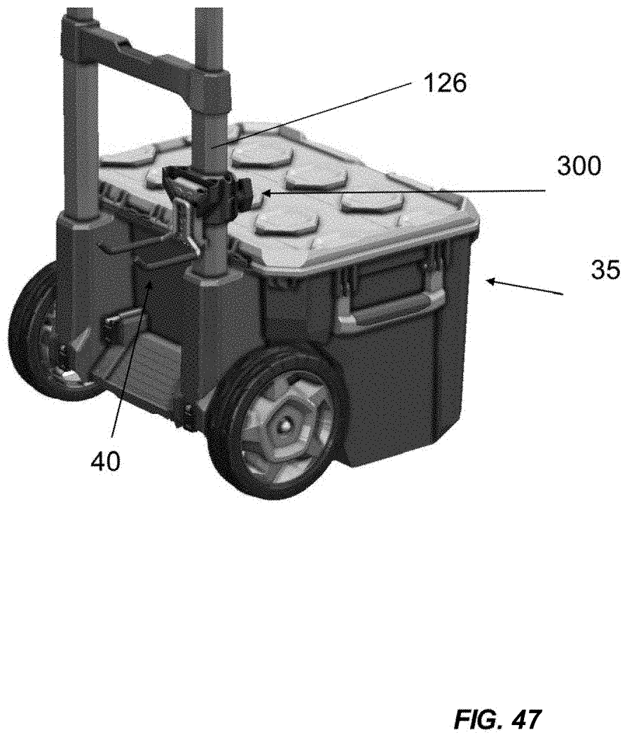

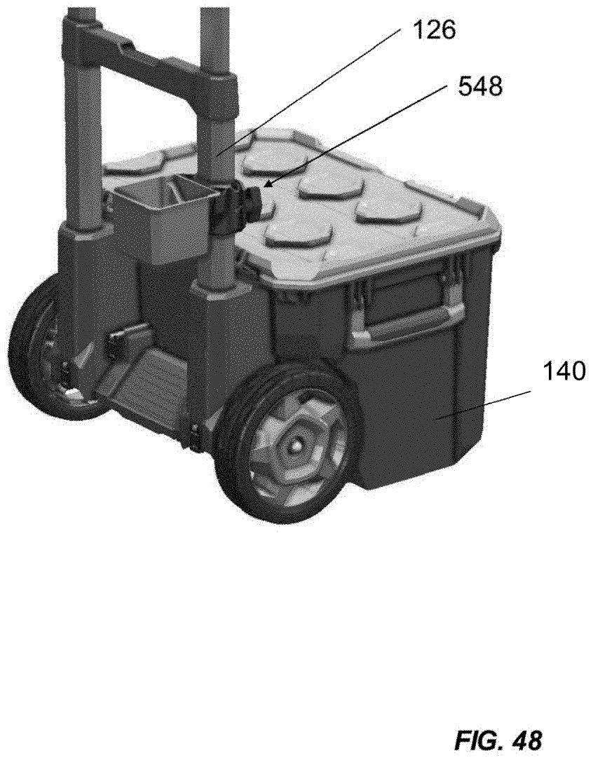

FIGS. 46-48 show a sixth modular accessory 548, or extrusion mount. As illustrated, the extrusion mount 548 includes a body 552 with a clamp 556 that is hinged or pivotably coupled to the body 552 to removably secure the extrusion mount 548 to a surface (e.g., a telescoping handle 126 of a toolbox 140) by tightening or loosening the clamp 556 via a grip or handle 560. The extrusion mount 548 also includes a mount interface 564 that to receive an accessory interface of an accessory (e.g., dual hook, a small storage bin) when the extrusion mount 548 is attached to the upright handle 126.

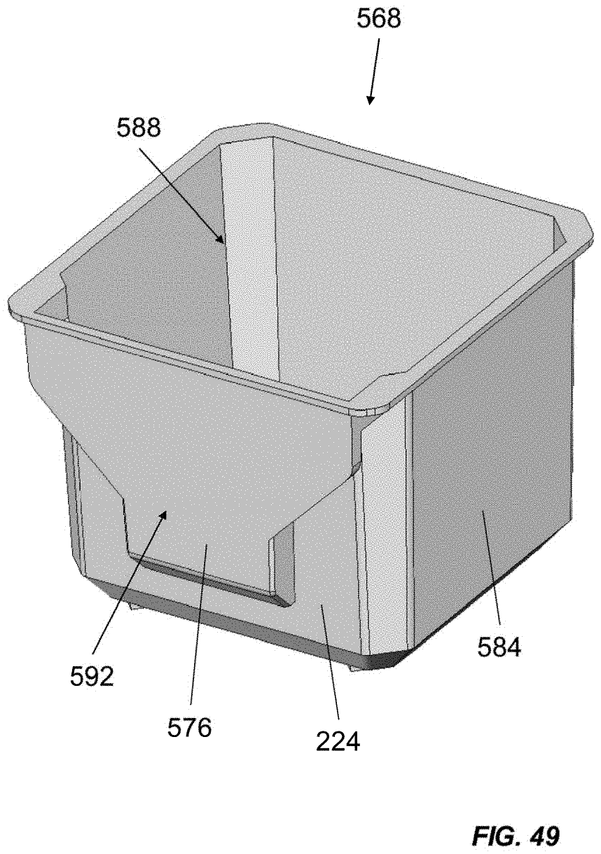

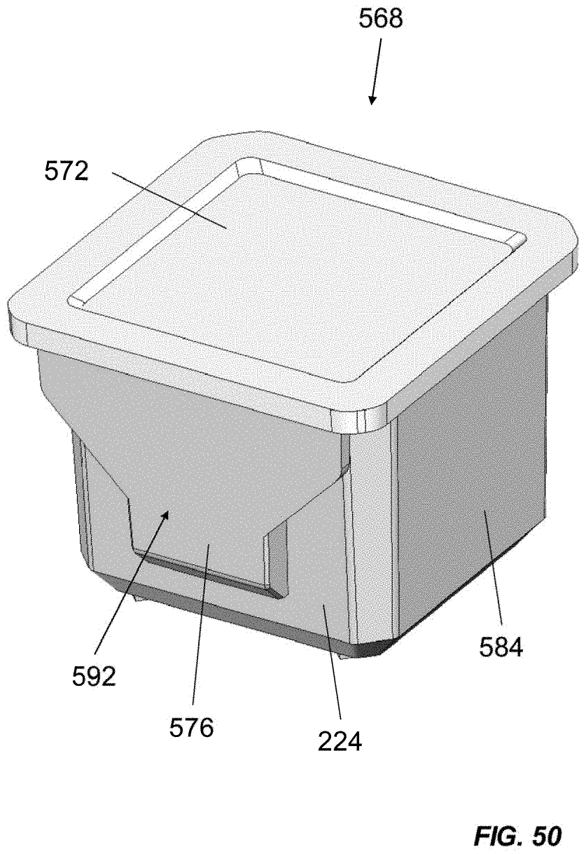

FIGS. 49 and 50 illustrate a seventh modular accessory 568 (e.g., small storage bin), and a lid 572 that is couplable to the small storage bin 568. The small storage bin 568 includes an accessory mount 576 extending from the rear wall 224 of the body 584 of the small storage bin 568. The body 584, or structure, defines an interior cavity 588 in which tools, loose items, etc., are receivable. The accessory mount 576 defines an accessory mount interface 592 that is couplable to a modular storage system. The lid 572 can be removably coupled to the body 584 and encloses the interior cavity 588 of the small storage bin 568. The small storage bin 568 is illustrated as having a cubic profile, although other profiles may be used.

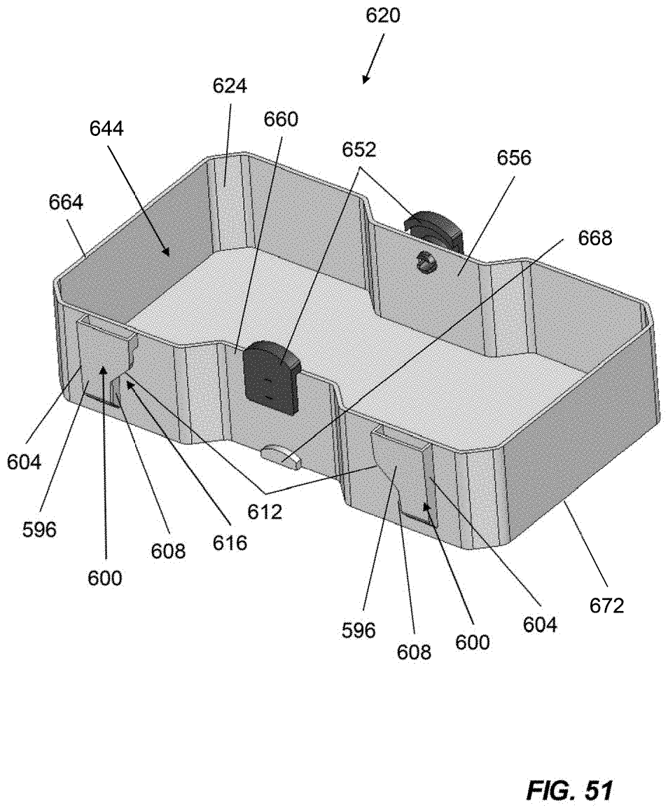

FIG. 51 illustrates another embodiment of an ninth accessory mount 596 defining a ninth accessory mount interface 600 (e.g., a modified Y profile). The ninth accessory mount 596 includes a first face 604 and a parallel second face 608 with an angled portion 612 extending away from the first and second faces 604,608 defining a single undercut 616. Two ninth accessory mounts may interact to engage spaced protrusions of a storage system (e.g., a wall rail 10) with the two ninth accessory mounts 596 cooperating to maintain the accessory in engagement with the storage system. The ninth accessory mount interface 600 may also be received in and/or interface with the mount interfaces of other storage components described herein.

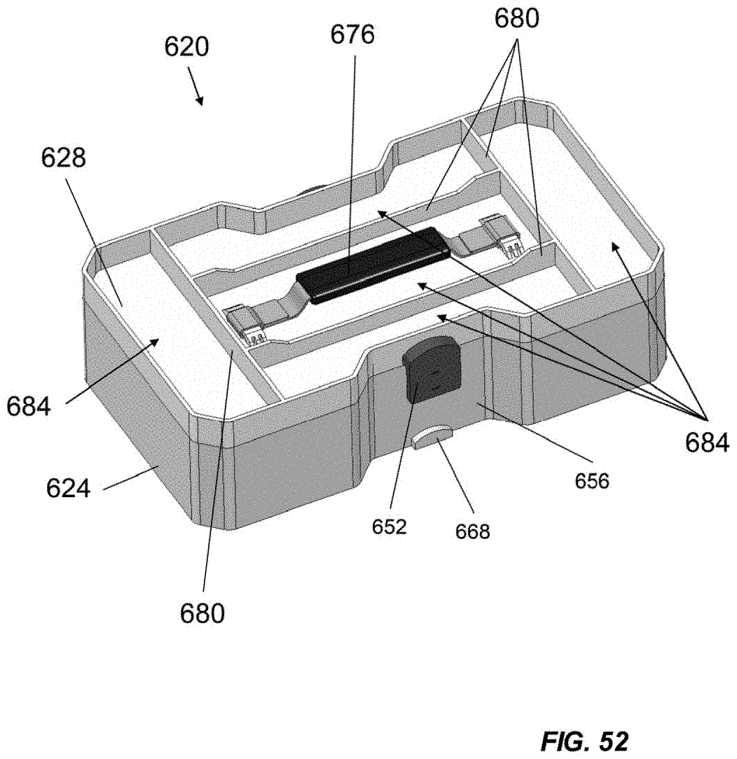

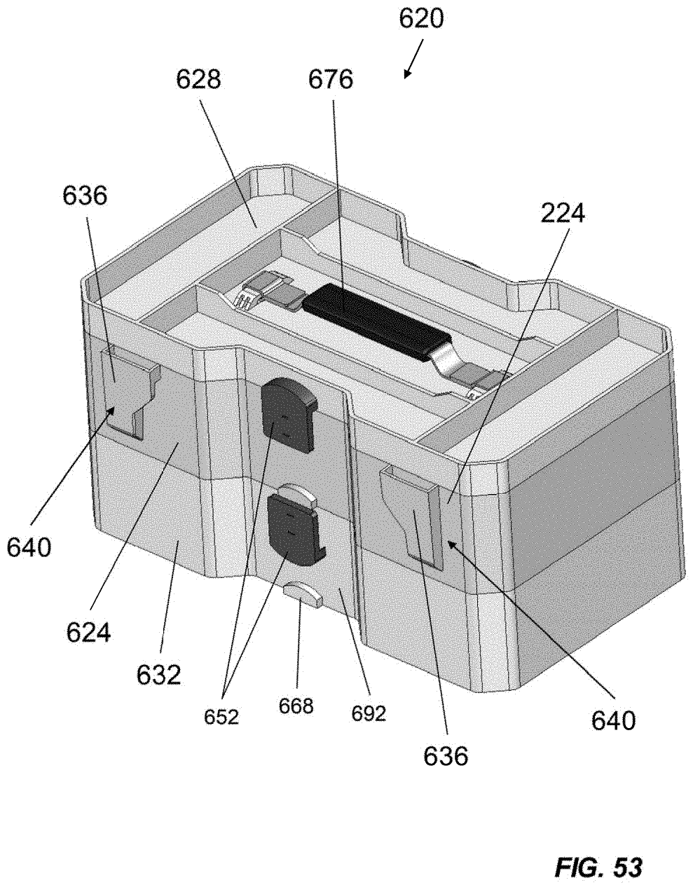

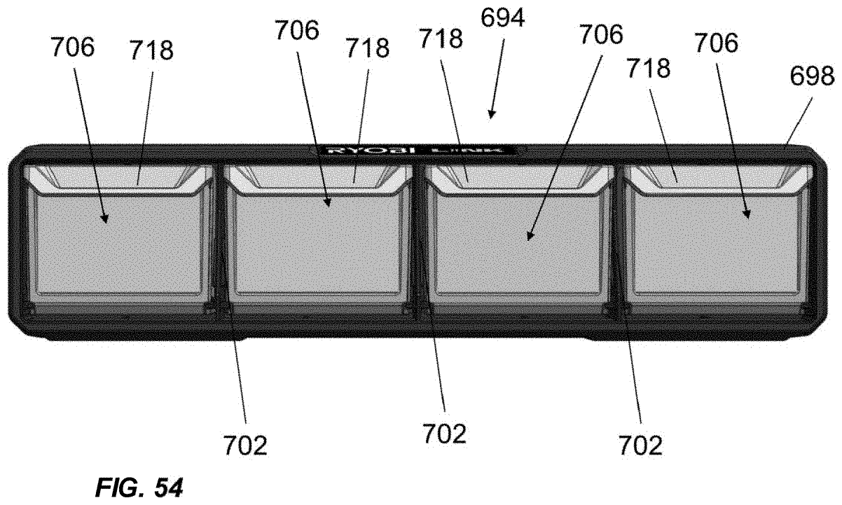

FIGS. 51-53 illustrate an eighth modular accessory 620 (e.g., stacking tray system) that forms a shelf system. The stacking tray system 620 includes a top tray 624, and may include a lid 628 and one or more lower trays 632. The top tray 624 (FIG. 51) includes accessory mounts 636 defining accessory mount interfaces 640 (e.g., modified Y accessory interfaces) extending from the rear wall 224 of the top tray 624 to removably couple the stacking tray system 620 to a mount interface (e.g., a second mount interface) of a storage system (e.g., a wall rail 10, toolbox 140, etc.). The top tray 624 defines a tray interior 644. A pair of latches 652 are pivotally coupled to the front and rear portions 656, 660 of the top tray 624 adjacent the top edge 664 of the top tray 624. Latching ridges 668 having a curved upper surface extend from the rear portion 660 the bottom edge 672 of the top tray. As shown in FIG. 52, the lid 628 is couplable to the top tray 624 by rotating the latches 652 coupled to the top tray 624 to engage the latching ridges 668 (substantially the same as or similar to the latching ridges of the top tray). The lid 628 includes a handle 676 for carrying the stacking tray system 620 when removed from the storage system. The lid 628 includes partitions 680 that define a plurality of pockets 684 in which loose pieces (e.g., fasteners) can be placed. As shown in FIG. 54, one or more lower trays 632 may be coupled to the top tray 624. The lower tray 632 defines an interior (similar to or the same as tray interior 644) and includes a pair of latches 652 pivotally coupled to the front and rear portions 688, 692 (front portion 688 the same as or similar to rear portion 692 but not shown) that pivot to engage the latching ridges 668 of the top tray 624 or other lower trays 632 included in the stacking tray system 620.

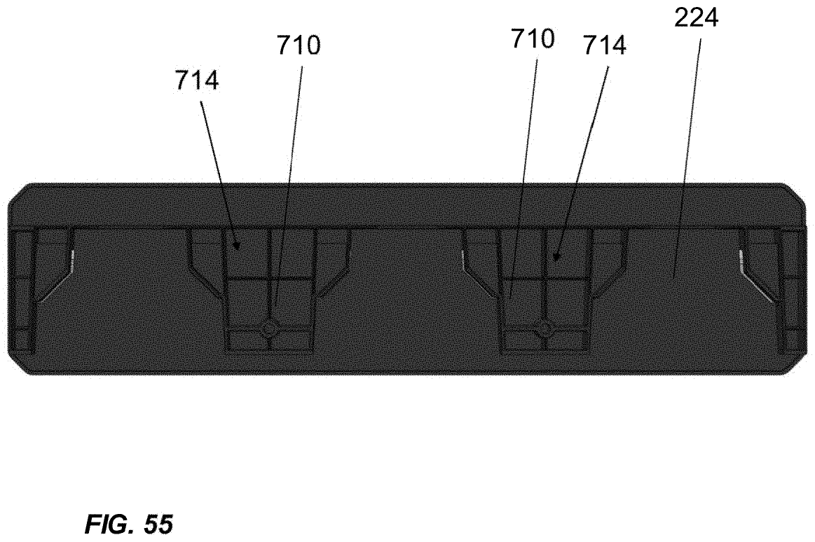

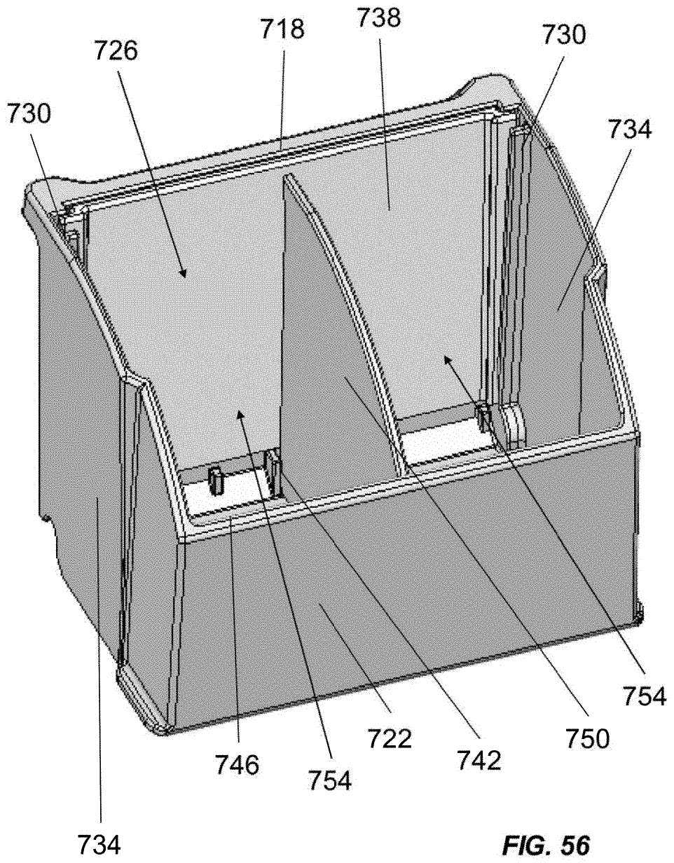

FIGS. 54-56 illustrate a ninth modular accessory 694 (e.g., small parts organizer). The small parts organizer 694 includes a base 698 with a rear wall 224 and substantially vertical partitions 702 defining a plurality of compartments 706 (e.g., four compartments, although it will be appreciated that other quantities may be used). As shown in FIG. 55, two accessory mounts 710 extend from the rear wall 224 and define accessory mount interfaces 714 (e.g., eighth accessory mount interfaces) for removably coupling the small parts organizer 694 to a wall rail 10 or other component of a storage system. As shown in FIGS. 54 and 56, a drawer 718 is insertable into each compartment 706. The drawer 718 may be slidable or pivotable relative to the base 698 of the small parts organizer 694. As shown in FIG. 56, each drawer 718 includes a body 722 defining a front opening 726. Ribs 730 extend substantially vertically along the side walls 734 of the drawer 718 adjacent the front opening 726. A front plate 738 is insertable between the ribs 730 and defines a front wall to prevent small parts from falling out of the drawer 718. The front plate 738 may be clear or opaque. Tabs 742 (one tab 742 shown, a second tab the same as or similar to the tab shown is positioned adjacent the tab 742) extend from the bottom 746 of the drawer 718 and a partition 750 is insertable between tabs 742 and defines compartments 754 within the drawer 718.

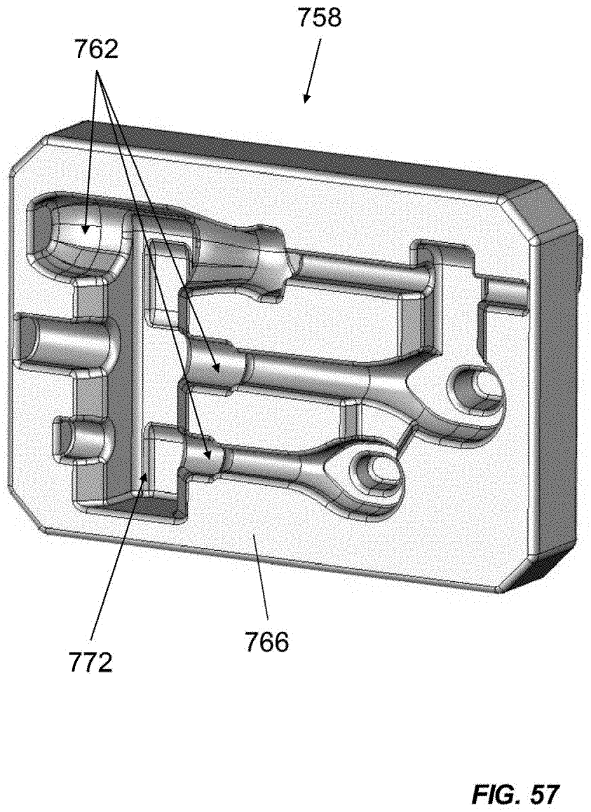

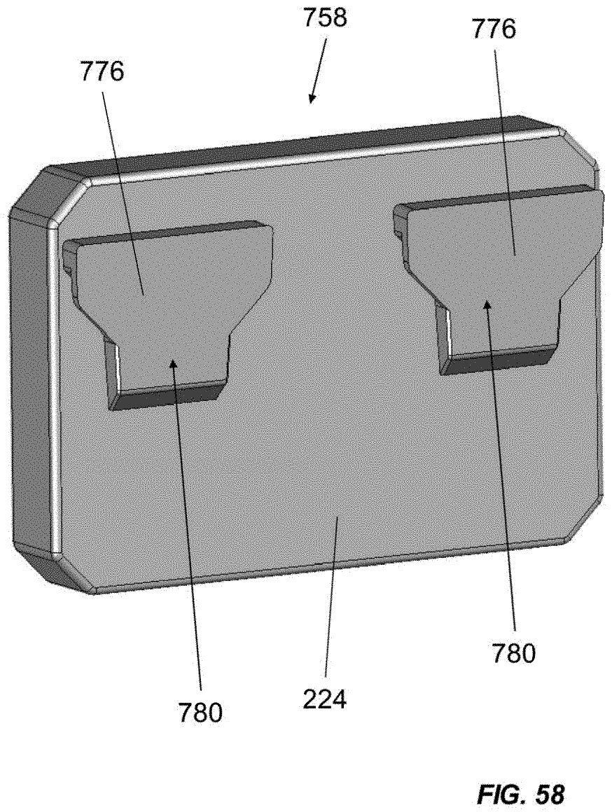

FIGS. 57 and 58 show a tenth modular accessory 758 (e.g., a hand tool organizer, a power tool organizer, and/or the like). The tool organizer 758 may define a plurality of recesses 762 shaped to receive longer tools in generally flush alignment with the front surface 766 of the tool organizer 758. The tool organizer 758 also includes a removal recess 772 spanning between the tool recesses for gripping the tools to remove or replace in the tool organizer 758. As illustrated, a screwdriver, long socket ratchet and short socket ratchet can be received by the tool organizer 758, although it will be appreciated that the organizer can include recesses shaped to receive other hand tools (e.g., wrenches, scissors, tape measurers, and/or the like), or power tools and accessories (e.g., a drill/driver, battery pack, etc.). Two accessory mounts 776 extend from the rear wall and define accessory mount interfaces 780 (e.g., eighth accessory mount interfaces), for removably coupling the tool organizer 758 to components of a storage system (e.g., a wall rail, a toolbox, etc.).

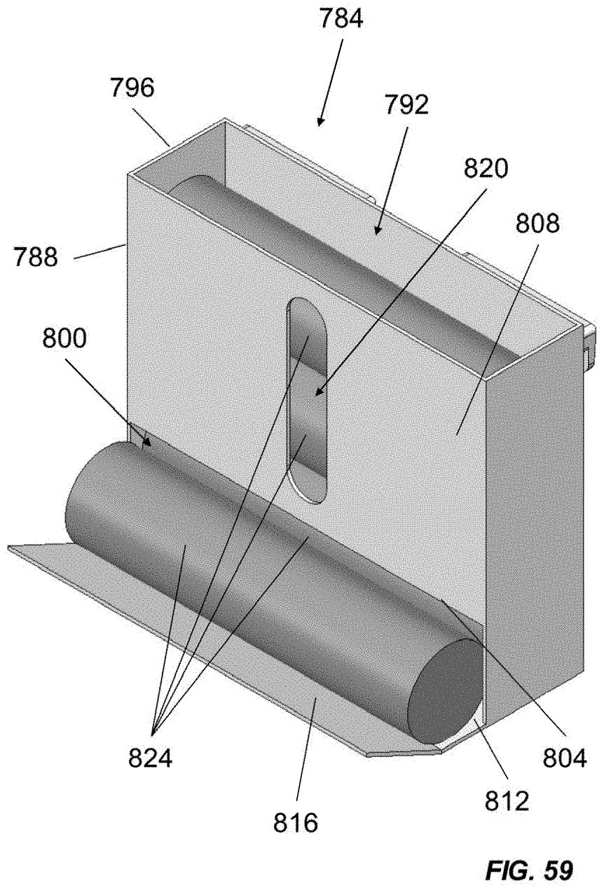

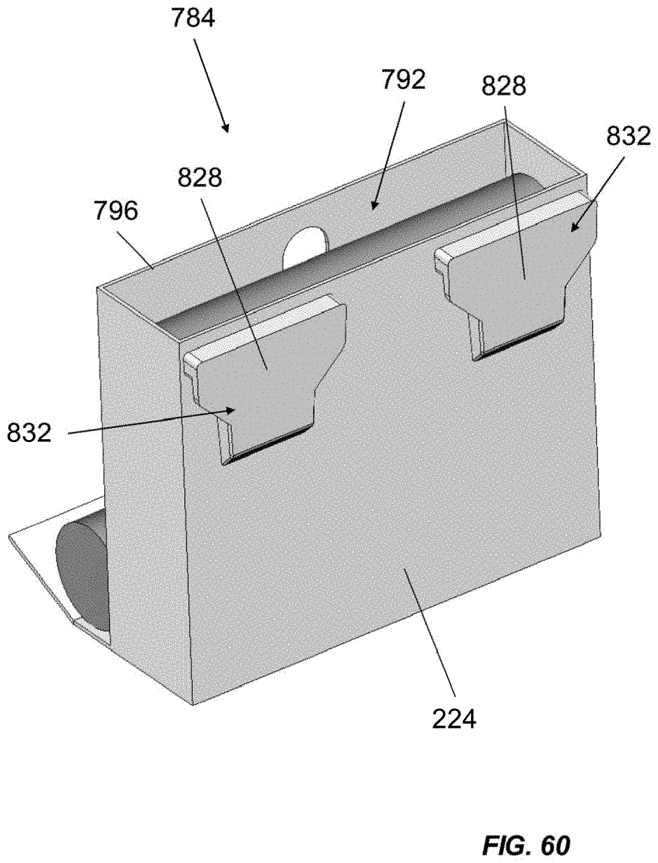

FIGS. 59 and 60 shows an eleventh modular accessory 784 (e.g., a tube dispenser). The tube dispenser 784 defines a storage compartment 788 having a box profile with an insertion hole 792 defined by the top edge 796 of the tube dispenser 784 and a tube outlet 800 at the bottom 804 of the front face 808. The bottom face 812 of the tube dispenser 784 extends forward of the front wall 808 and defines a dispensing platform. A tube stop 816 extends at an upward angle from the bottom face 812. The front wall 808 defines a slot 820 configured to allow horizontal placement and removal of a plurality of tubes 824 (e.g., caulk tubes, grease tubes, epoxy tubes, etc.) in the storage compartment 788. As a tube 824 is removed from the dispensing platform, the force of gravity on the remaining tubes 824 results in the tubes dropping such that the next tube 824 in the tube dispenser 784 is received on the dispensing platform. As shown in FIGS. 59, accessory mounts 828 (e.g., two accessory mounts) extend from the rear wall 224. The accessory mounts 828 define accessory mount interfaces 832 (e.g., eighth accessory mount interfaces for removably coupling the tube dispenser 784 to components of a storage system.

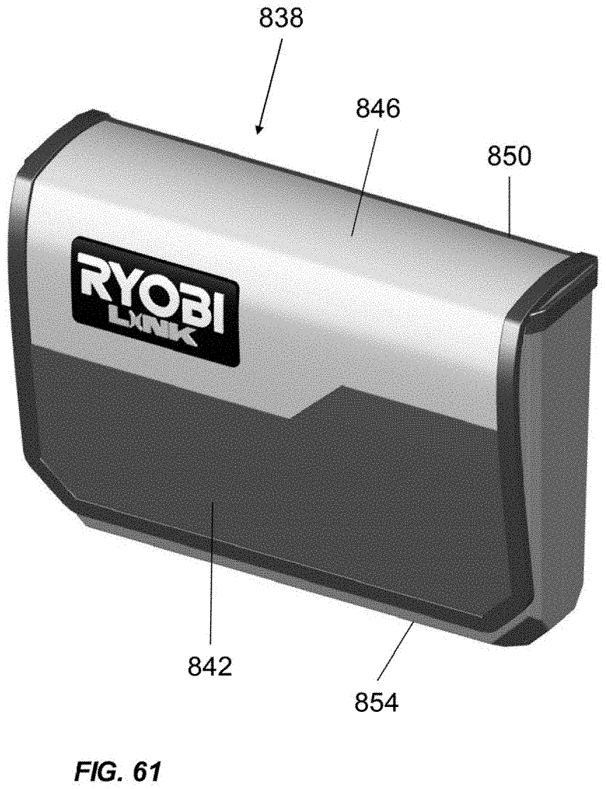

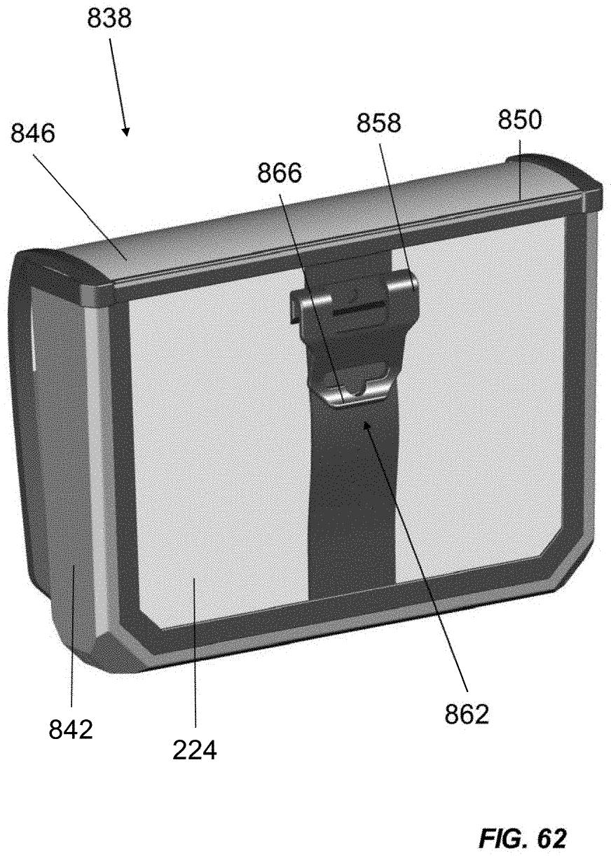

FIGS. 61 and 62 a twelfth modular accessory 838 (e.g., a sandpaper storage folder). The sandpaper storage folder 838 includes a receptacle portion 842 that defines an interior and a cover 846 pivotally coupled to the top rear edge 850 of the receptacle portion 842. The cover 846 extends over the interior of the receptacle portion 842 and downward at least partially along the front face 854 of the receptacle portion 842. Sheets of sandpaper are placeable in the interior of the receptacle portion 842. An accessory mount 858 extends from the rear wall 224 of the receptacle portion 842 and defines an accessory mount interface 862 (e.g., an eighth accessory mount interface). The accessory mount 858 is removably couplable with a mount interface (e.g., a second mount interface) of components in a storage system. The accessory mount 858 has a curved portion 866 that contacts the rear wall 224 for clipping the sandpaper storage folder 838 to a belt or other strip-like structure.

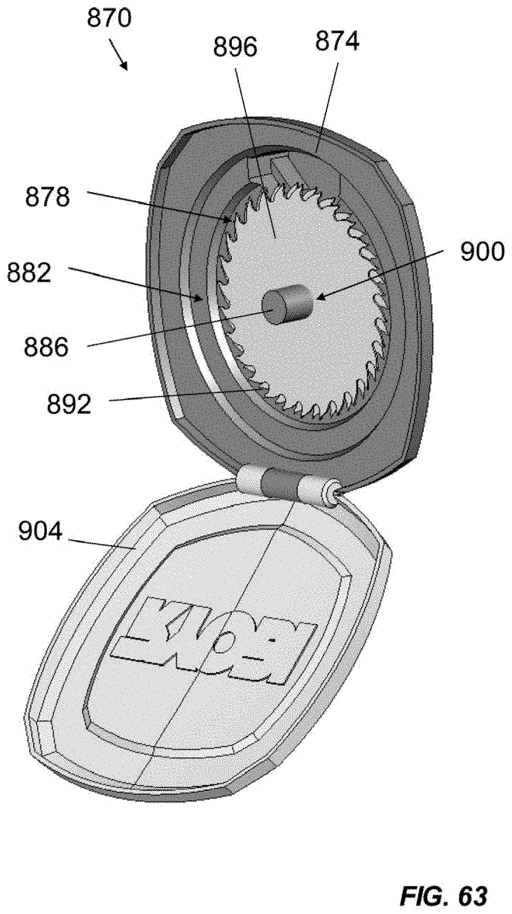

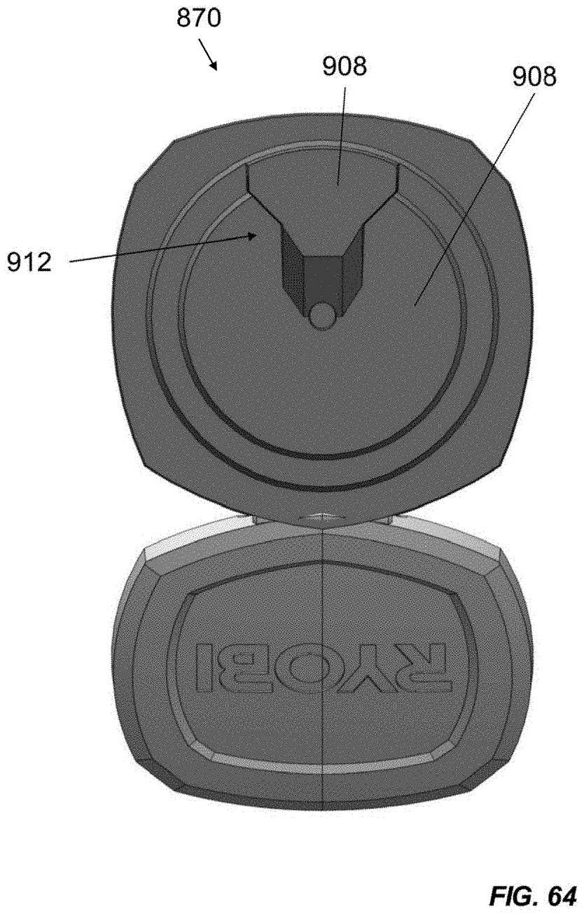

FIGS. 63-70 show a thirteenth modular accessory 870 (e.g., circular saw blade storage). FIGS. 63 and 64 illustrate a first embodiment of a circular saw blade storage 870. The circular saw blade storage 870 has a base 874 defining concentric recesses 878, 882 having different diameters (e.g. a smaller diameter and a larger diameter), with a shaft extending 886 through the center of the recesses 878, 882 from the bottom face 892 of the circular saw blade storage 870. The recesses 878, 882 receive circular saw blades 896 having different diameters (e.g., 7.25″, 10″, 12″, etc.). The shaft 886 is received by the mount hole 900 of the circular saw blades 896. A lid 904 is pivotally coupled to the base 874 and encloses the recesses 878, 882 preventing the saw blades 896 from cutting or otherwise damaging other components of the storage system with which the circular saw blade storage 870 is coupled. As shown in FIG. 64, the base 874 includes an accessory mount 908 that extends from the rear wall 224 and defines an accessory mount interface 912 (e.g., an eighth accessory mount interface) for removably coupling the circular saw blade storage 870 with a mount interface of components in a storage system.

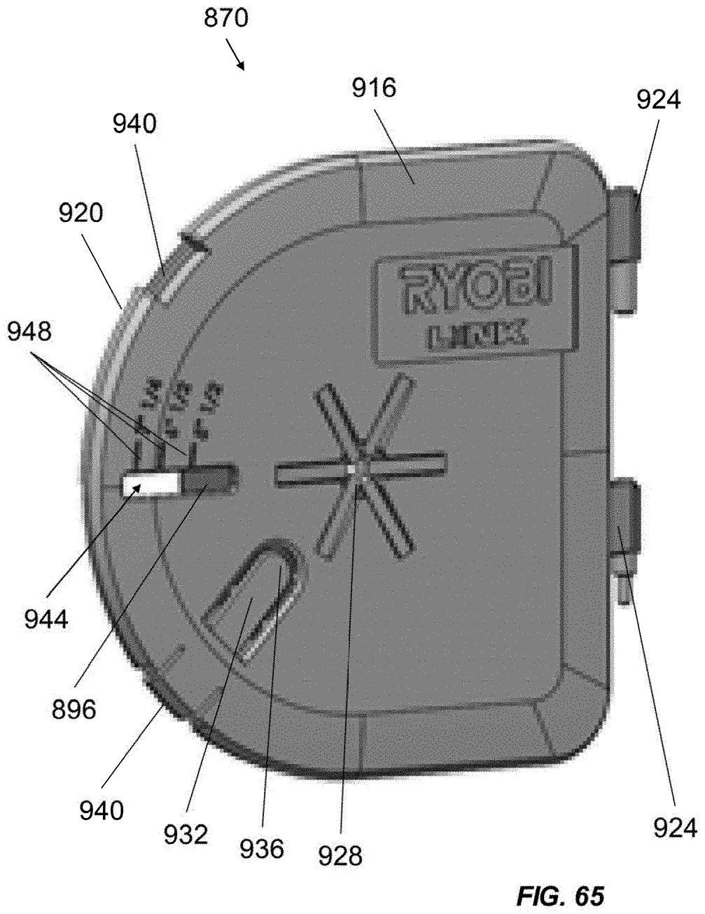

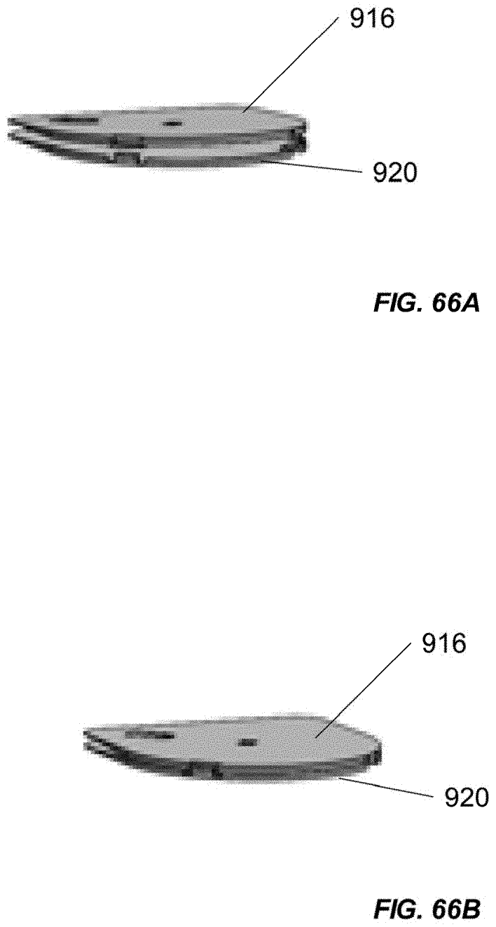

FIGS. 65-67 illustrate another embodiment of a circular saw blade storage 870. The circular saw blade storage 870 has a front plate 916 pivotally coupled to a back plate 920 at hinges 924 and is pivotable between an open position (FIG. 66A) and a closed position (66B). The circular saw blade storage 870 receives circular saw blades 896 in the interior defined between the front and back plates 916, 920. A blade clasp 928 having a star or asterisk profile extends into the interior and is received by the mount hole 900 of the circular saw blades 896. A cantilevered removal tab 932 extends from the front plate 916 and has a free end 936 that is depressible to allow application of a force to a circular saw blade 896 for removal of the circular saw blade 896 from the blade clasp 928. The front and back plates 916, 920 define latch clips 940 to maintain the closed position of the circular saw blade storage 870. The front and/or back plate 916, 920 includes a viewer hole 944 with markings 948 formed adjacent the viewer hole 944 indicative of the diameter of the circular saw blades 896 stored in the interior of the circular saw blade storage 870.

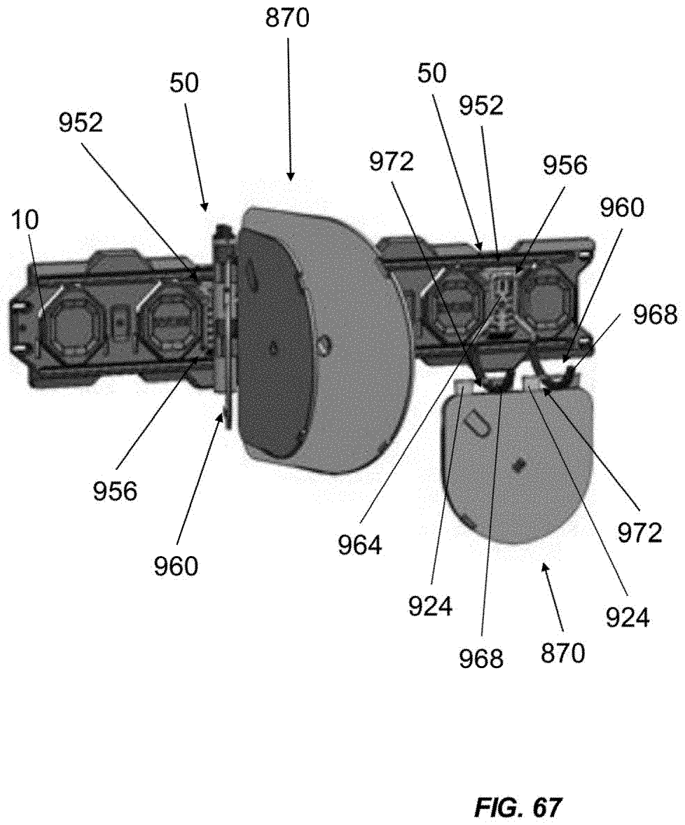

As shown in FIG. 67, the hinges 924 of the circular saw blade storage 870 engage an accessory mount 952. The accessory mount 952 defines an accessory mount interface 956 configured to engage a mount interface (e.g., second mount interface 50) of components in a storage system and a circular saw blade storage interface 960 configured to receive the hinges 924 of the circular saw blade storage 870. In one embodiment illustrated in FIG. 67, the storage mount includes a base 964 that defines the accessory mount 952 that is engageable with a mount interface (e.g., second mount interface 50). A pair of hooks 968 define the circular saw blade storage interface 960, which extend from the base 964 and are received in hook holes 972 defined in the hinges 924.

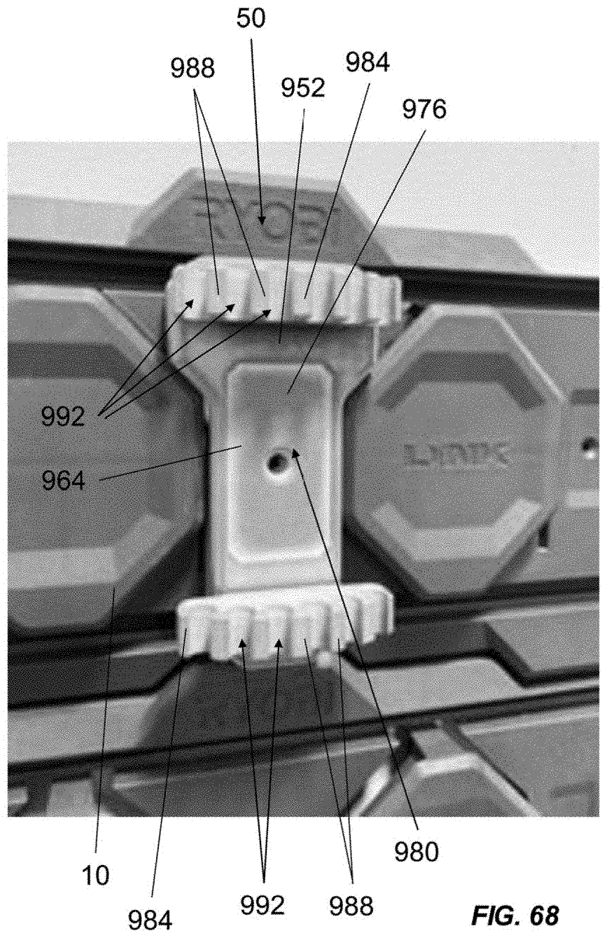

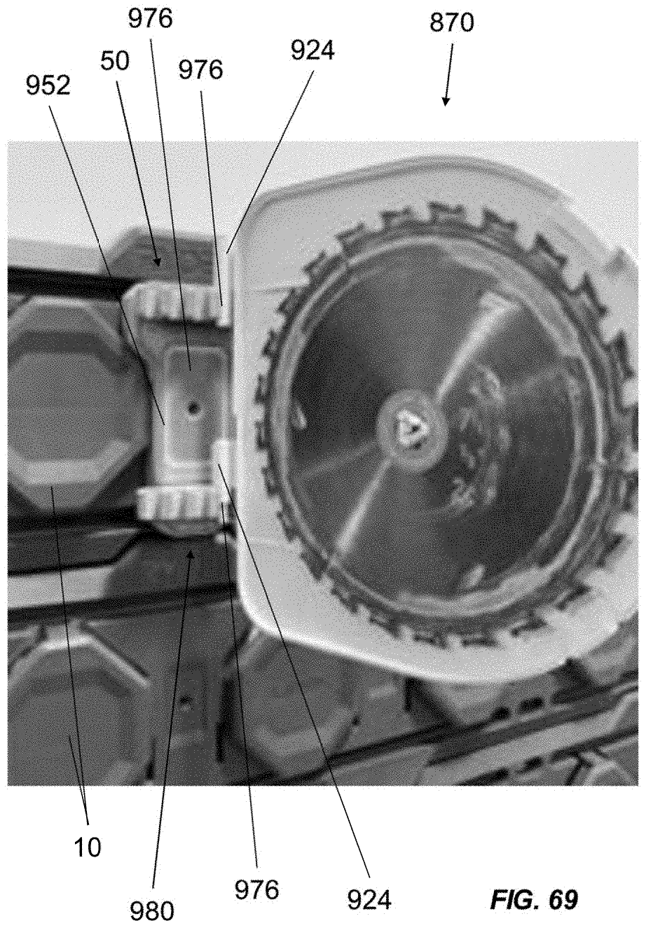

As shown in FIGS. 68 and 69, in another embodiment, the hinges 924 of the circular saw blade storage 870 define a pivot portion 976 that is engageable with another embodiment of an accessory mount 952. The storage mount 952 includes a base 964 defining an accessory mount interface 980 (e.g., an eighth accessory mount interface) that is engageable with a mount interface (e.g., second mount interface 50) of a storage system (e.g., a wall rail 10). A pair of substantially horizontal coupling portions 984 extend from the base 964 at opposite ends thereof. Each coupling portion 984 includes a plurality of fingers 988 defining recesses 992 therebetween in which the pivot portions 976 of a plurality of circular saw blade storages 870 are receivable (FIG. 69). The recesses 992 are sized to receive the pivot portions 976 of the hinges 924 in an interference fit.

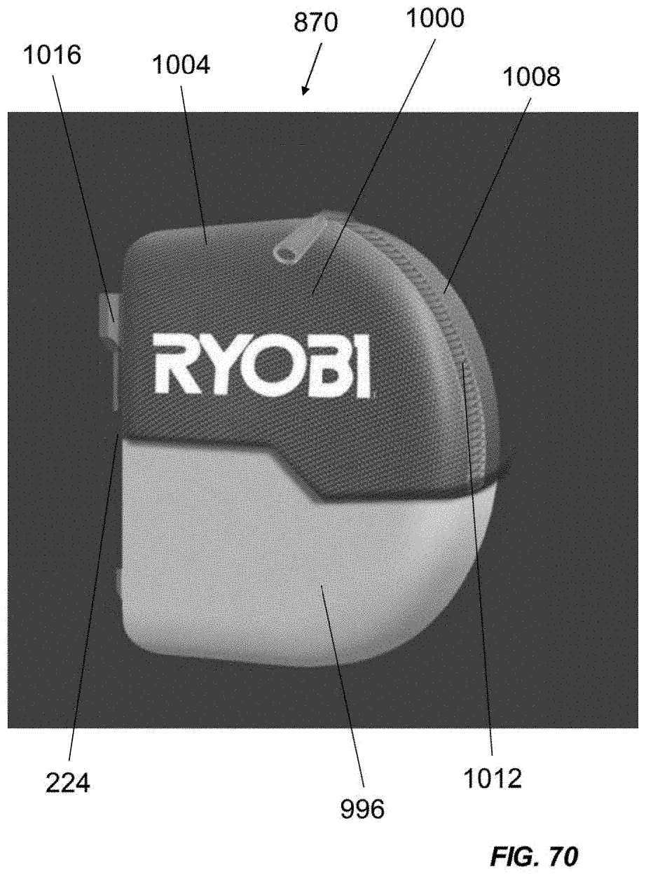

As shown in FIG. 70, in another embodiment of the circular saw blade storage 870, the circular saw blade storage 870 may include a lower portion 996 comprising a rigid material and an upper portion 1000 that is soft good (e.g., cloth, canvas, nylon, polyester, or other non-rigid material), although a semi-rigid or rigid good may be used instead. The upper portion 1000 may include a front half 1004 and a rear half 1008 coupled by a zipper 1012 (or other coupling structure). In other embodiments, the upper and lower portions both comprise a soft good. The circular saw blade storage 870 includes a rear wall 224 and an accessory mount 1016 extending from the rear wall 224. The accessory mount 1016 defines an accessory mount interface (e.g., eighth accessory mount interface) that is couplable to a mount interface (e.g., a second mount interface 50) of a storage system.

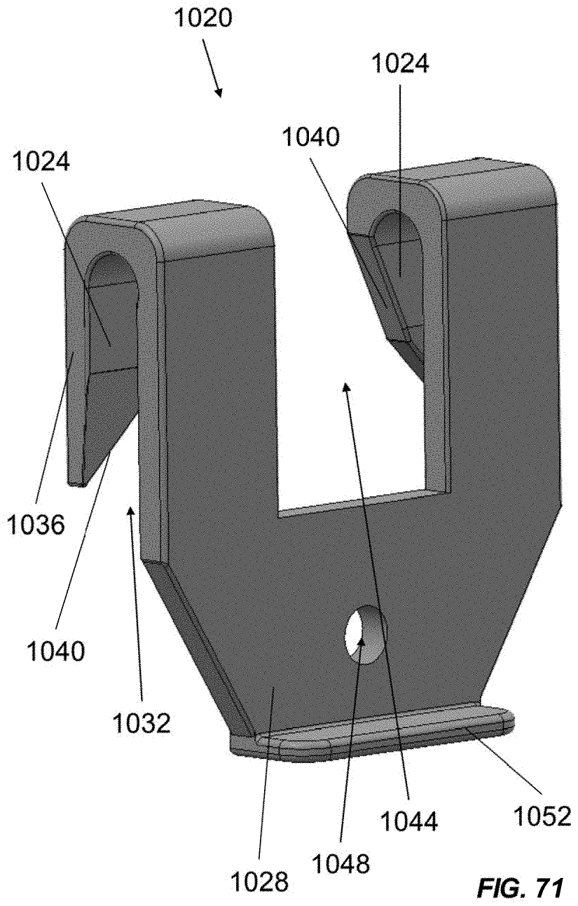

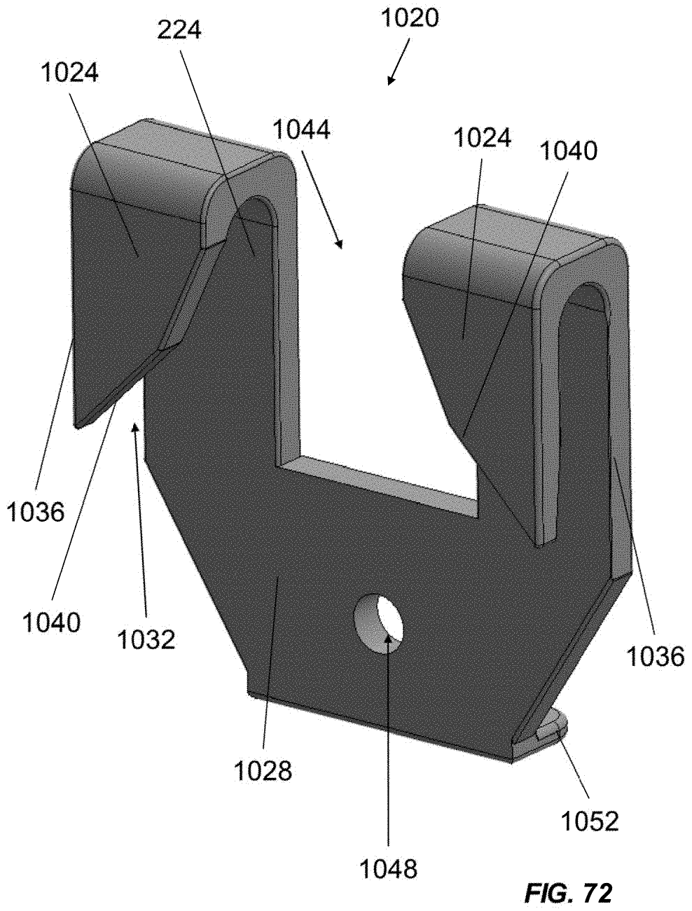

FIGS. 71 and 72 show a fourteenth modular accessory 1020 (e.g., a belt clip). The belt clip 1020 includes an accessory mount (e.g., two hooks 1024) extending from the rear wall 224 of the base 1028 and defining an gap 1032 between the hooks 1024 and the base 1028 and configured to receive a mount interface (e.g., the protrusion 14 defining the fourth mount interface 62 or fifth mount interface 66). The gap 1032 may receive a belt or other strip-like structure. Each hook 1024 includes a flat outer surface 1036 and an inner angled surface 1040 that extends away from the outer surface 1036 and toward the center of the belt clip 1020. The inner angled surface may include an inflection point. The hooks 1024 define an accessory mount interface 1044 that engages the mount interface. The base 1028 defines a hole 1048 and a platform 1052 extends from the base 1028 away from the hooks 1024.

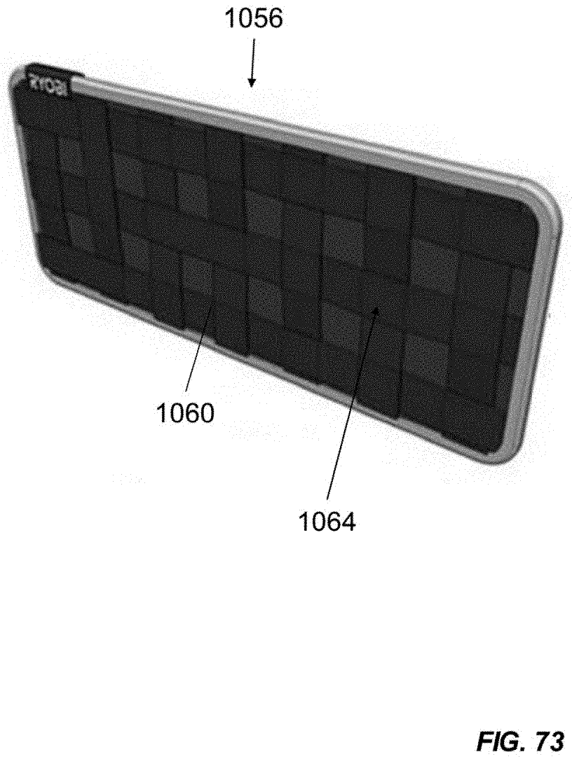

FIGS. 73 and 74 shows a fifteenth modular accessory 1056 (e.g., a storage panel). The storage panel 1056 includes a front surface 1060 including a front mount interface 1064 (e.g., MOLLE, shown in FIG. 73, although other front mount interfaces such as pegboard, hook and loop fasteners, French cleats or other interface to which a structure is couplable). Two accessory mounts 1064 extend from the rear wall 224 of the storage panel 1056 and define accessory mount interfaces (e.g., eighth accessory mount interface). The accessory mounts 1060 are couplable to mount interfaces of components in a storage system.

Another exemplary storage accessory is embodied as a cord wrap. The cord wrap is configured with one or more hooks or surfaces to receive a wrapped cord, wire, string, tape, or wound product and includes at least one accessory interface for removably coupling the cord wrap with a mount interface of a storage system.

Another exemplary storage accessory is embodied as a spool/reel holder. The reel holder includes structures, for instance, a shaft with a retaining structure, that receive a spool of a wound product (e.g., wire, tape, twine, etc.) and allow the spool to spin freely in relation to the surface such that the wound product can be dispensed, cut, and utilized. The reel holder includes an accessory interface for removably coupling the spool holder to the mount interface of components in a storage system.

Another exemplary storage accessory is embodied as a holder that is configured to receive a cylindrical body (e.g., a cup, can, spray can). The cup holder includes sidewalls that are structured to holder a can vertically or horizontally. The holder includes at least one accessory interface for removably coupling the cord wrap with a mount interface of a storage system.

Another exemplary storage accessory is embodied as a pouch configured to hold small items (e.g., fasteners). The pouch may be flexible and include a drawstring at the top for securing the contents of the pouch. In other embodiments, the pouch may be configured to receive items specific to a trade (e.g., electrical or plumbing supplies). In still other embodiments, the pouch may receive tools and be configured to roll for compact storage (e.g., a tool roll). The pouch includes at least one accessory interface for removably coupling the pouch to the mount interface of components in a storage system.

Another exemplary storage accessory is embodied as communication device (e.g., a handheld speaker, walk/talkie, etc.). An accessory interface is integrally formed with the housing of the communication device and is removably couplable to the mount interface of components in a storage system.

Another exemplary storage accessory is a horizontal hammer holder. The hammer holder is configured to support the handle of the hammer while preventing the heavier claw portion of the hammer from causing the hammer to fall from the hammer holder. The hammer holder includes an accessory interface that is removably couplable to the mount interface of components in a storage system.

Another exemplary storage accessory is a small format tool (multimeter, laser level, stud finder, scale, label maker, weather computer with an atomic clock and is internet connectible and provides weather updates, a timer, phone charger, for instance on that includes a small inverter and is ONE+™ compatible, a thermal camera, etc.) including an accessory interface integrally formed with the housing of the tool. The accessory interface is removably couplable to the mount interface of components in a storage system.

In another embodiment, a storage accessory is a shoe including an accessory interface that engages a mount interface and is couplable to the battery foot, that is, the portion of the tool housing which receives a battery pack. The accessory interface engages a protrusion extending from the wall rail and extends around and receives the protrusion. When coupled to a wall rail, a battery-operated tool may be slidable into engagement with the shoe thereby coupling the tool to the wall rail.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

1. A modular accessory compatible with a first storage component having first mount interfaces and a second storage component different from the first storage component and having second mount interfaces, the modular accessory comprising:
a structure configured to hold or support one or more objects; and
an accessory mount coupled to the structure and defining an accessory mount interface configured to engage one or more of the first mount interfaces and configured to engage one or more of the second mount interfaces.

2. The modular accessory of claim 1, wherein the accessory mount is integrally formed with the structure.

3. The modular accessory of claim 1, wherein the accessory mount includes a pair of spaced vertical portions and angled portions extending from each of the vertical portions and defining an undercut.

4. The modular accessory of claim 1, wherein the accessory mount includes an upper surface and a lower surface having a length shorter than a length of the upper surface, and a pair of angled surfaces extending between the upper surface and the lower surface.

5. The modular accessory of claim 1, wherein the accessory mount includes a first bar and a second bar, and an angle is defined between the first bar and the second bar.

6. The modular accessory of claim 1, wherein the accessory mount includes a plurality of edges defining a polygon having a profile of a pentagon, a hexagon, or an octagon.

7. The modular accessory of claim 1, wherein the accessory mount includes a plurality of edges defining a square profile.

8. The modular accessory of claim 1, wherein the accessory mount is coupled to a rear wall of the structure.

9. A system comprising:
a first storage component having one or more first mount interfaces;
a second storage component different from the first storage component and including one or more second mount interfaces;
a modular accessory including a structure configured to hold or support one or more objects; and
an accessory mount coupled to the modular accessory and defining an accessory mount interface configured to engage one or more of the first mount interfaces, the accessory mount further configured to engage one or more of the second mount interfaces.

10. The system of claim 9, wherein the first storage component is a rail that is configured to attach to a wall and the second storage component is a toolbox.

11. The system of claim 10, wherein the accessory mount is configured to separately engage the first storage component and the second storage component without modification of the accessory mount.

12. The system of claim 9, wherein the first storage component includes a plurality of protrusions that define an undercut, the first mount interface disposed between the upper angled portions of a first protrusion and an adjacent second protrusion.

13. The system of claim 9, wherein the first storage component includes a protrusion having a first upper angled surface and a second upper angled surface, the first upper angled surface and the second upper angled surface defining the first mount interface.

14. The system of claim 9, wherein the second storage component includes a plurality of protrusions on an interior surface, wherein the second mount interface is disposed between at least two of the plurality of protrusions.

15. The system of claim 9, wherein the second storage component includes a plurality of protrusions on an exterior surface, wherein the second mount interface is disposed between at least two of the plurality of protrusions.

16. The modular accessory of claim 9, wherein the accessory mount includes a pair of spaced vertical portions and angled portions extending from each vertical portions and defining an undercut.

17. The modular accessory of claim 9, wherein the accessory mount includes an upper surface and a lower surface having a length shorter than a length of the upper surface, and a pair of angled surfaces extending between the upper surface and the lower surface.

18. The modular accessory of claim 9, wherein the accessory mount includes a first bar and a second bar, and an angle is defined between the first bar and the second bar.

19. The modular accessory of claim 9, wherein the accessory mount includes a plurality of edges defining a polygon having a profile of a pentagon, a hexagon, or an octagon.

20. The modular accessory of claim 9, wherein the accessory mount includes a plurality of edges defining a square profile.
